(19) United States
(12) Patent Application Publication
(10) Pub. No.: US 2004/0106088 A1
(43) Pub. Date: Jun. 3, 2004

(54) Systems and methods for computer-based testing using network-based synchronization of information

(76) Inventors: Gary F. Driscoll, Pennington, NJ (US); Frank Strasz, Princeton, NJ (US); Kenneth Berger, Skillman, NJ (US); Steve Hendershott, Lawrenceville, NJ (US); Edwardine Adams, Ottsville, PA (US); Ramchandra S. Vaidya, Princeton Junction, NJ (US); Darshan M. Timbadia, East Windsor, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/611,724

(22) Filed: Jul. 1, 2003

Related U.S. Application Data
(62) Division of application No. 09/901,797, filed on Jul. 10, 2001.
(60) Provisional application No. 60/217,433, filed on Jul. 10, 2000.

(51) Int. Cl. G09B 19/00

(52) U.S. Cl. 434/118

(57) ABSTRACT

A system for computer-based testing facilitates network distribution of testing materials and software. The system comprises a back-end, a servicing unit, and one or more testing centers. The back-end stores test questions and software, and includes software that prepares the test questions and software for distribution to the servicing unit. The servicing unit includes a web server that interfaces with software installed at a testing center. The testing center includes administrative software that contacts' the web server at the servicing center to obtain updates to test questions and testing software in a process called “synchronization.” Synchronization is also the process by which the test center reports test results and candidate information back to the servicing unit by means of the servicing unit's web server. The testing center includes a software component called the Test Delivery Management System (TDMS), which uses Java-based technology to deliver test questions to examinees at one or more testing stations located at the test center.

### CROSS-REFERENCE TO RELATED CASES

This case claims the benefit of U.S. Provisional Application No. 60/217,433, entitled “Systems and Methods for Computer-Based Testing Using Network-Based Synchronization of Information,” filed Jul. 10, 2000.

### FIELD OF THE INVENTION

The present invention relates generally to the field of computer-based testing and, more particularly, to a system and method for using a computer network to remotely deliver testing materials to a computer-based testing center, and for using such a network to remotely administer and service the testing center.

### BACKGROUND OF THE INVENTION

For many years, standardized tests have been administered to examinees for various reasons, such as for educational testing or for evaluating particular skills. For example, academic skills tests (e.g., SATs, GREs, LSATs, GMATs, etc.) are typically administered to a large number of students. Results of these tests are used by colleges, universities and other educational institutions as a factor in determining whether an examinee should be admitted to study at that educational institution. Other standardized testing is carried out to determine whether or not an individual has attained a specified level of knowledge or mastery of a given subject.

Traditionally, standardized tests have been paper-based: examinees are gathered in a room and given paper test materials, usually comprising a question booklet and an answer sheet that is computer-readable by optical or magnetic means. With the growth of the computer industry and the reduction in price of computing equipment, fields in which information has traditionally been distributed on paper have begun to convert to electronic information distribution means—and the field of standardized testing is no exception. A modestly-priced computer system can be used in place of a paper test booklet to administer test questions to a testing candidate. The use of computer systems to deliver test questions to candidates is generically described as “computer based testing” (CBT). One system for computer-based testing is described in U.S. Pat. No. 5,827,070 (Kershaw, et al.), which is herein incorporated by reference in its entirety.

While systems for computer-based testing have been available, they have generally relied on outdated technologies, such as physical delivery of test questions and related software. While physical delivery of data and software on data storage media (e.g., on optical disk or magnetic tape) is reliable and secure, it is slow and cumbersome because it has a built-in lag time (i.e., the time it takes to deliver the medium), and it requires a person to physically handle the delivery medium (i.e., to install the disk or mount the tape). While installation of initial testing materials on physical media may be acceptable, using physical media to provide recurring updates to the materials may, in some cases, be unacceptably cumbersome. With advances in networking, as exemplified by the growth in the capacity and usage of the Internet, network communication is quickly supplanting physical delivery in many contexts, and modern expectations demand no less than the speed that network communications can provide, while still retaining the security and reliability of physical delivery. In the testing context, the need to preserve security and reliability when introducing network distribution cannot be overemphasized.

In view of the foregoing, there is a need for a computer-based testing system that addresses these requirements, which have not been met in the prior art.

### SUMMARY OF THE INVENTION

The computer-based testing system of the present invention provides an architecture for the preparation and delivery of computer-based tests. The architecture comprises a back-end unit, a servicing unit, and one or more test center units. These units are separated from each other by firewalls, which selectively enforce isolation of the various units.

The back-end unit includes a data store of tests and testing-related software, a package migration tool, and a software distribution management application. The tests and testing-related software in the data store may be “legacy” items—i.e., items from older computer-based testing systems that are convertible for use with the system of the present invention. The package migration tool extracts the tests and software from the data store, processes it as necessary (e.g., converting “legacy” information to a new format), and forwards it to a repository in the servicing unit. The software distribution management tool provides to the servicing unit information that pertains to the ultimate release of packages to test centers—e.g., information about versions or updates, or information about which test centers are entitled to receive particular packages.

The servicing unit comprises a holding database and various web servers. The holding database receives tests and software across the firewall from the package migration tool, and also receives release and update information across the firewall from the software distribution management application. A first web server communicates with the test centers and provides new tests and software (or updates to tests and software) to the test centers in a process known as “synchronization”—which is related to the synchronization process used in distributed database systems. A second web server is used for technical support, and it provides troubleshooting information to the technical support personnel at the entity that operates the servicing unit.

Each test center comprises a test delivery management system (TDMS), and, optionally, a number of testing stations. (In an alternative arrangement, a single computing device, such as a laptop computer, may serve as both the TDMS and the testing station.) The TDMS communicates with a web server at the servicing unit, and it allows the test center's information (e.g., tests and software) to be synchronized with the central information stored at the servicing unit —i.e., if the servicing unit web server and the TDMS have different information, the data can be updated. The TDMS operates through administrative software that interfaces with the web server at the servicing unit, for example by a secure sockets layer (SSL) over the Internet. Alternatively, the TDMS could communicate with the servicing unit web site by means of a private network. Each testing station is preferably a computing device (e.g., a desktop or laptop computer). One computing device may be assigned to a test-center administrator (TCA), who is a person who runs the test center and uses the software to perform functions such as registering candidates and commencing electronic test delivery to candidates. The TDMS hosts Java business logic and a testing database. Testing stations connect to the TDMS and receive test questions and other information to be displayed to the candidate working at each station. Testing stations may display the information provided by the TDMS through software dedicated for that purpose, although, through the use of off-the-shelf Internet-based technologies such as Java, the testing stations may deliver a test using a general-purpose browser.

Other features of the invention are described below.

### BRIEF DESCRIPTION OF THE DRAWINGS

The foregoing summary, as well as the following detailed description, is better understood when read in conjunction with the appended drawings. For the purpose of illustrating the invention, like references numerals represent similar parts throughout the several views of the drawings, it being understood, however, that the invention is not limited to the specific methods and instrumentalities disclosed. In the drawings:

FIG. 1 is a block diagram of an exemplary computer system, in which aspects of the invention may be implemented;

FIG. 2A is a block diagram of a first exemplary distributed architecture for a computer-based testing system according to aspects of the invention;

FIG. 2B is a block diagram of a second exemplary distributed architecture for a computer-based testing system according to aspects of the invention;

FIG. 2C is a diagram showing communication between a servicing center and a test center using a communications protocol in accordance with aspects of the invention;

FIG. 3 is a block diagram showing the deployment of the invention in a first testing context;

FIG. 4 is a block diagram showing the deployment of the invention in a second testing context; and

FIG. 5 is a flow diagram of a process for providing testing material to a test center in accordance with aspects of the invention.

### DETAILED DESCRIPTION OF THE INVENTION

Overview

The proliferation of computer networks, such as the Internet, has made rapid information delivery readily available to everyone, and Internet-related technologies, such as Java, have simplified the processing of this information. Along with this increased information delivery and processing potential comes increased consumer expectation that this technology will be used in fields of information in which physical delivery of information has been the norm. Standardized testing is such a field. The present invention provides a system and method for using a network infrastructure and modern software tools to deliver and administer tests, without compromising the security of the test, or flexibility of the test format, which have been enjoyed under more traditional testing infrastructures.

Exemplary computer system

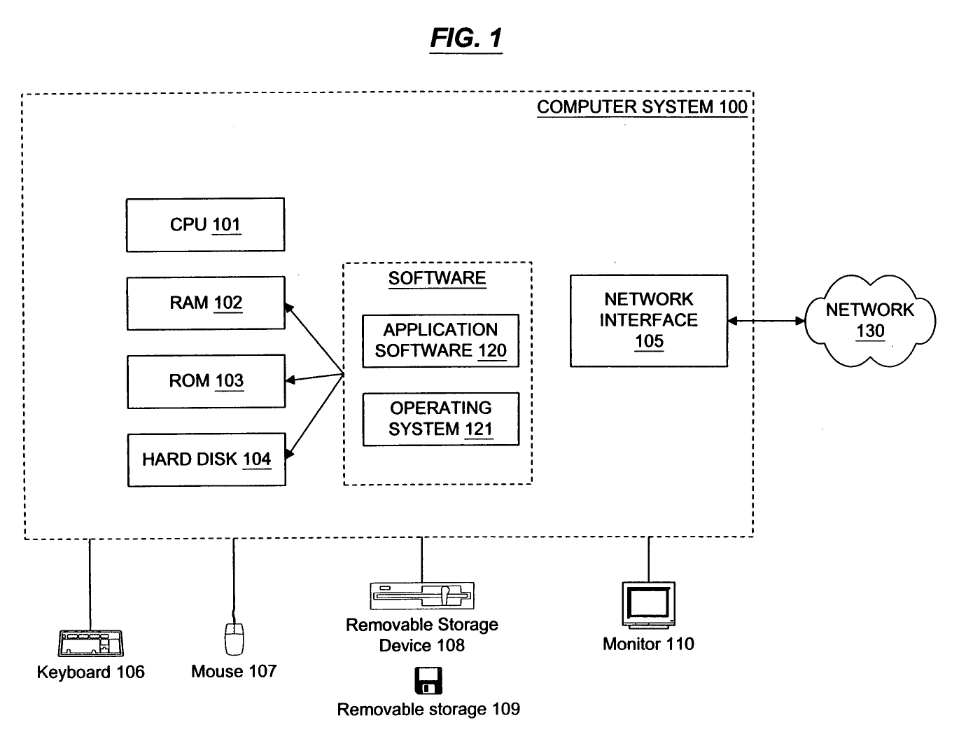

FIG. 1 illustrates an exemplary computer system in which aspects of the invention may be implemented. As discussed below, several features of the invention are embodied as software, where the software executes on a computing device. Computer system 100 is an example of such a device.

Computer system 100 preferably comprises the following hardware components: a central processing unit (CPU) 101, random access memory (RAM) 102, read-only memory (ROM) 103, and long term storage in the form of hard disk 104. It should be understood that the above-listed hardware components are exemplary and by no means limiting of the type of computing system that may be used with the software features of the invention. Computer systems having only a subset of those components depicted, or additional components, may be used without departing from the spirit and scope of the invention. Computer system 100 also comprises software components, such as an operating system 121 and software 120. These software components may reside in the various types of memory depending upon circumstance. For example, an application program 120 may reside on hard disk 104 when it is not in use, but may be transferred to random access memory 102, or into the cache memory of CPU 101, when it is being executed. The various hardware components of the computer system 100 may be communicatively connected to each other by means of a bus (not shown).

Computer system 100 may also be associated with certain external input/output (I/O) devices, which permit computer system 100 to communicate with the outside world. In the example of FIG. 1, computer system 100 includes a keyboard 106, a mouse 107, a monitor 110, and an external removable storage device 108. External removable storage device may, for example, be a 3½-inch magnetic disk drive, CD-ROM drive, DVD-ROM drive, or magnetic tape drive, and removable storage 109 is a medium appropriate for device 108, such as a 3½-inch magnetic disk, optical disk, or magnetic tape. Computer system 100 may also include a network interface 105 which permits computer system 100 to transmit and receive information over computer network 130. Computer network 130 may be a wide-area network (such as the Internet), a local-area network (such as Ethernet), or any other type of network that may be used to connect computer systems.

As discussed below, various components of the invention comprise software designed to perform a particular function or functions. It will be understood that such software may carry out its function(s) by executing on a computing device such as computer system 100, or any similar computing device.

System architecture

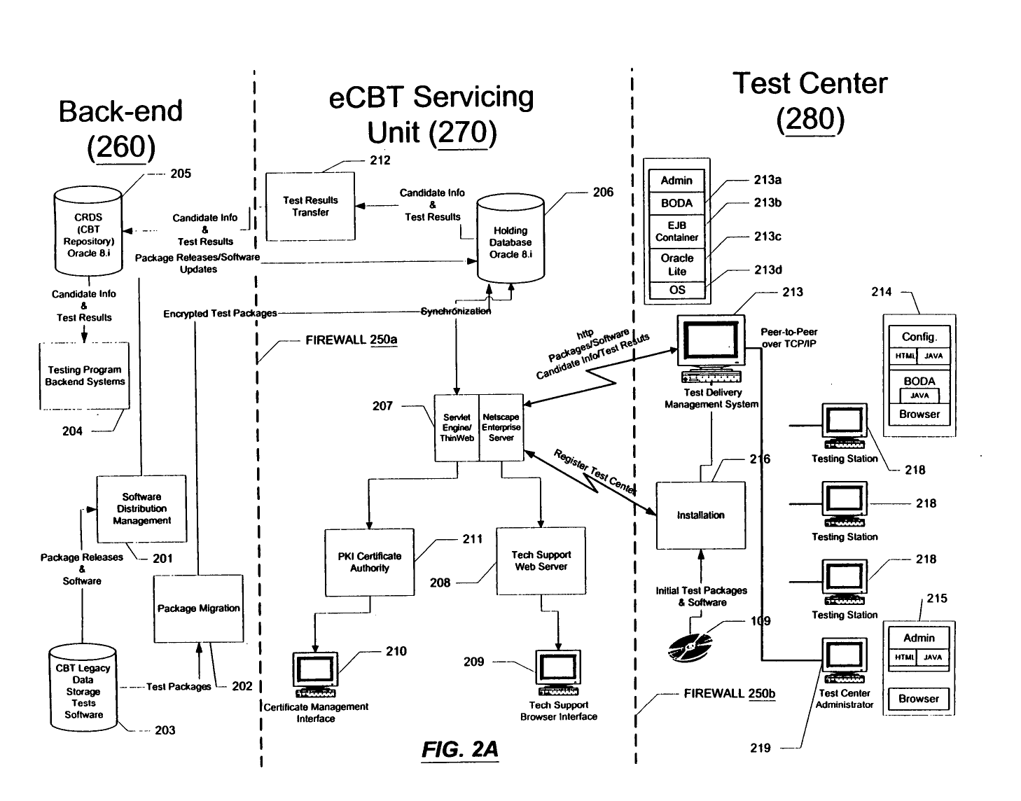

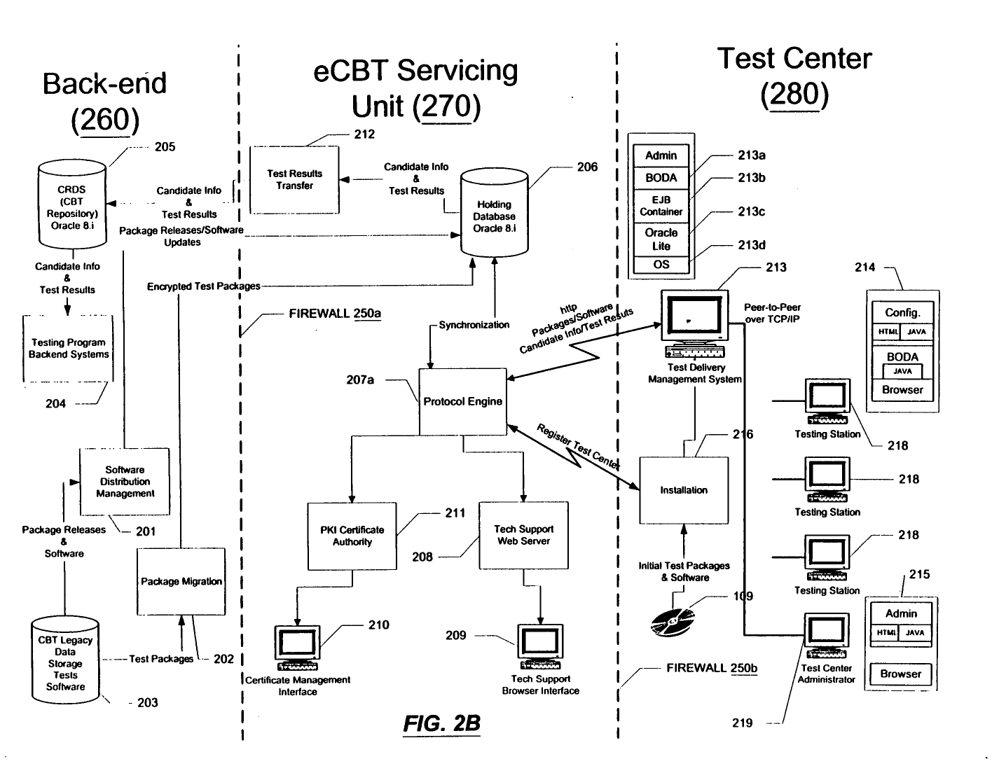

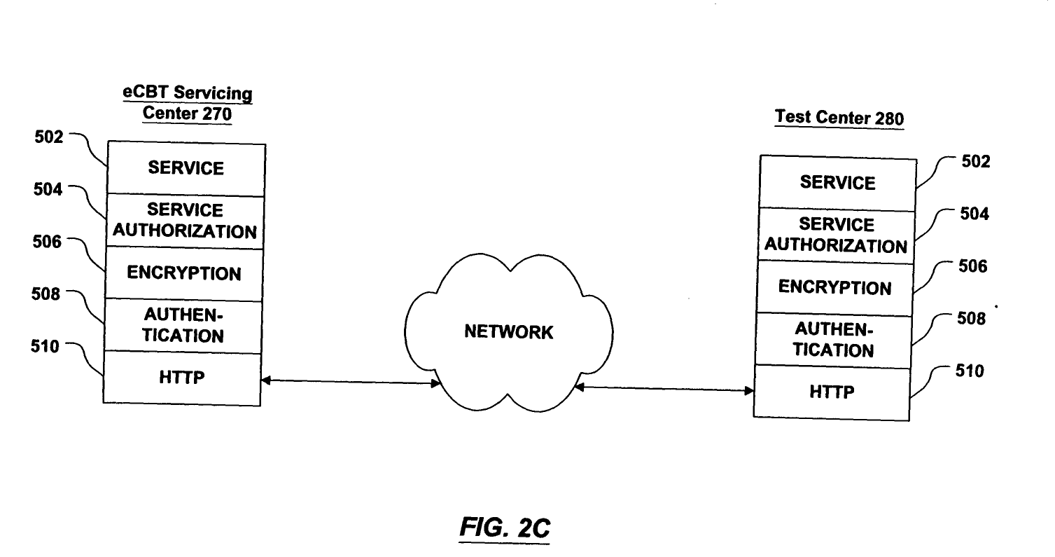

FIG. 2A shows the various components of the distributed architecture for a CBT system adapted for use with the Internet (an “eCBT” system). The architecture comprises a back-end 260, an eCBT servicing unit 270, and one or more test centers 280. These units are separated by firewalls 250a and 250b. Firewalls 250a and 250b enforce the isolation of the units 260, 270, and 280, but permit certain communications among them. Firewalls 250a and 250b may, for example, be implemented by firewall software executing on a computing device, such as a router that connects the various units.

As shown by the various communication lines in FIG. 2A, communication is permitted between certain components of eCBT servicing unit 270 and back-end 260, and also between certain components of eCBT servicing unit 270 and test center 280. For example, software distribution management object 201 is part of back-end 260 and holding database 206 is part of eCBT servicing unit 270, but software distribution management object 201 communicates with holding database 206 across firewall 250a, as shown by the line connecting those two structures. Where communication lines are shown between components in FIG. 2A, it is to be understood that the communication may occur by any means that permits computing systems to communicate with each other, such as computer network 130 (shown in FIG. 1). It should be noted that, while FIG. 2A shows a single test center 280, it will be appreciated by those of skill in the art that plural test centers 280 may be serviced by a single eCBT service center 270.

Back-end 260 preferably comprises a software distribution management application 201, a package migration tool 202, CBT “legacy” data storage 203, testing program back-end systems 204, and CBT repository database 205. eCBT servicing center 270 preferably comprises holding database 206, web server 207, technical support web server 208, technical support browser interface 209, certificate management interface 210, PKI (“public key infrastructure”) certificate authority 211 and test results transfer module 212. Test center 280 preferably comprises a test delivery management system (TDMS) 213, a client configuration and BODA (“Business Object Delivery Application”) object 214 (see below), a test administration station 219 (with a test administrator system 215 installed thereon), an installation object 216, and testing stations 218. These elements are described in further detail below.

Components of back-end 260

Back-end 260 may include a software distribution management application 201, a package migration tool 202, CBT “legacy” data storage 203, testing program back-end systems 204, and CBT repository database 205.

Software distribution management application 201 is responsible for updating the test package and delivery software release information in holding database 206. This information includes information about which test packages and delivery software components are available for download by which test centers. Software distribution management application 201 also updates holding database 206 with additional distribution control information, such as: earliest install date, latest install date, and test package expiration. Software distribution management application 201 may be implemented as software running on a computing device (such as computer system 100), which is preferably located behind firewall 250a as depicted in FIG. 2A. The implementation of the above-disclosed functions of software distribution management application 201 would be readily apparent to those of skill in the art and, therefore, the code to implement such an application is not provided herein. Software distribution management application 201 sends information (i.e., package releases and software updates) to holding database 206 across firewall 250a. In order to send such information, software distribution management application 201 may make use of the various communication means on the computing device on which it is running, such as network interface 105. Software distribution management application 201 receives information from “legacy” data storage 203 (see below), which may be a database that resides on, or is accessible to, the computing device that hosts back-end 260.

Package migration tool 202 extracts software and test package data from CBT legacy data storage database 203 (see below). Package migration tool 202 also encrypts the item-level data for each test package. The term “item,” as used herein, refers to a test question preferably comprising a stem, a stimulus, responses, and directions, or some subset of those elements. The concept of an “item,” as it relates to the field of testing, is more fully discussed at column 1, lines 25-39 of U.S. Pat. No. 5,827,070 (Kershaw, et al.), which is incorporated by reference in its entirety. Package migration tool 202 may perform encryption by any conventional encryption method, such as those based on symmetric key algorithms or public/private key algorithms. Package migration tool 202 may be implemented as software running on the computing device that hosts back-end 260 (e.g., computer system 100), and such software may use the communication means of its host computing device (e.g., network interface 105) to communicate with holding database 206 across firewall 250a. The implementation of the functions of package migration tool 202 would be readily apparent to those of skill in the art and, therefore, the code to implement such a tool is not provided herein.

CBT “legacy” data store 203 is a database that stores tests and software created for use with prior CBT systems, such as the system described in U.S. Pat. No. 5,827,070 (Kershaw, et al.). As described above, software distribution management application 201 and package migration tool 202 both use information that is stored in CBT “legacy” data storage 203 and process such information for use with the eCBT system. In this way, software distribution management application 201 and package migration tool 202 facilitates backward compatibility of the eCBT system with older systems. (It should be noted that a particularly advantageous way to achieve backward compatibility of the software stored in “legacy” data storage 203 is to wrap the legacy code with Java using JNI (“Java Native Interface”).) However, it will be appreciated by those of skill in the art that “legacy” data storage 203 need not contain information that was used, or was specifically adapted to be used, in a prior CBT system; on the contrary, “legacy” data storage 203 may simply be a database that stores test items and testing software in a form that may be processed by software distribution management application 201 and package migration tool 202. For example, data store 203 may contain information in a compressed format, a human-readable format, or any other format in which it is convenient to store testing information for use with the eCBT system, and software distribution management application 201 and package migration tool 202 may be adapted accordingly to use the information in data storage 203 in whatever format is chosen (e.g., XML).

CBT repository 205 is a database that stores test candidate information and test results. Candidate information may include the candidate's name and address, and/or other information pertaining to the candidates who take tests at test centers 280. Test results may include such information as the candidate's answers to the various test items, and/or the candidate's score on the test. CBT repository is preferably implemented using a general-purpose commercial database management system, such as an ORACLE database system. CBT repository receives information from test results transfer application 212 across firewall 250a.

Testing program backend systems 204 comprise software applications that process the test results and candidate information stored in CBT repository 205. For example, systems 204 may include software that correlates the test results and candidate information and produces test score reports, statistical analysis, etc.

Components of eCBT Servicing Unit 270

eCBT servicing center 270 may include a holding database 206, a web server 207, a technical support web server 208, a technical support browser interface 209, a certificate management interface 210, a PKI certificate authority 211, and a test results transfer module 212.

Holding database 206 serves as the central data repository for eCBT. Preferably, holding database 206 is implemented using a relational database (for example, ORACLE 8i enterprise database). Holding database 206 stages all encrypted test package and software components awaiting download by test centers 280. Holding database 206 also captures all candidate information, including test results, which have been uploaded by test centers 280. Holding database 206 may retain a subset of the candidate information for fixed period of time (e.g., a 30-day period). Additionally, the holding database 206 houses all information regarding each test center 280, including detail address and contact information, each TDMS installed at the center, and synchronization activity.

Web server 207 is the front door to the test delivery management system 213, which resides at test center(s) 280. Web server 207 provides the means for test center 280 to communicate with components of eCBT servicing unit 270, including the holding database 206 and technical support web server 208. Web server 207 acts mainly as a pass through to a Java Enterprise Engine (e.g. JRUN V3.0 or ThinWEB servlet). Java Enterprise services allow the test center to communicate indirectly directly with the holding database 206 to retrieve any test packages migrated by package migration tool 202 and marked for distribution by software distribution management application 201. Additionally, web server 207 allows test center 280 to upload the candidate test results to holding database 206.

Technical support web server 208 interacts with the web server 207 to provide troubleshooting information to the technical support personnel associated with the provider of an eCBT system. For example, Education Testing Service (ETS) of Princeton, N.J., provides tests using an eCBT system, and may have such a technical support group which evaluates the troubleshooting information received through technical support web server 208. A browser-based interface 209 allows technical support personnel to retrieve and evaluate information from the holding database 206. Such information may include the test center status, test center synchronization activity and/or test package release details.

eCBT servicing unit 270 may also include a public key infrastructure (PKI) certificate authority 211, which has associated therewith a certificate management interface 210. Communication between eCBT servicing unit 270 and test center(s) 280 is controlled by computer security techniques. These techniques involve encryption and authentication, which may be implemented by assigning an asymmetric (“public/private”) key pair to each test center 280. PKI certificate authority 211 can be used to validate public key certificates proffered by test center(s) 280 before eCBT servicing unit 270 provides test center(s) 280 with any information. PKI certificate authority 211 may be used in conjunction with a Lightweight Directory Access Protocol (“LDAP”) server (not shown).

Test results transfer module 212 is a software component that receives candidate information and test results from holding database 206, and transfers such information and results to back-end 260 across firewall 250a.

Components of Test Center 280

Test center 280 may include a test delivery management system (TDMS) 213, a client configuration and Business Object Delivery Application (BODA) object 214, a test administration station 219 (with a test administrator system 215 installed thereon), an installation object 216, and zero or more testing stations 218.

Test Delivery Management System (TDMS) 213 is an application server that hosts the Java business logic and the test center ORACLE Lite, or other relational database. Individual testing stations 218 connect to TDMS 213 and receive test questions and other information to be displayed to the candidate. TDMS 213 also provides reliable data transactioning and full recoverability for a candidate in the event that a test must be restarted. Preferably, all candidate information is stored by TDMS 213 in its ORACLE Lite database 213c, so that no candidate information need be saved at testing stations 218. TDMS 213 is also responsible for automated synchronization, which interacts with web server 207. Automated synchronization is a process by which the TDMS database is updated with new test package or software components. During the synchronization process, candidate results are also uploaded from TDMS 213 back to eCBT servicing unit 270.

TDMS 213 preferably includes various software components. The components include the Business Object Delivery Application (BODA) 213a (see below), Enterprise JavaBeans™ container 213b, an ORACLE lite database 213c, and an operating system 213d.

Client Configuration and Business Object Delivery Application (BODA) 214 run on testing station 218. However, the software and the test package data are stored in the TDMS ORACLE Lite database 213c. The Client Configuration provides the Graphical User Interface (“GUI”) interface for the administrator to login and configure testing station(s) 218. It also presents the candidate login interface. (It should be noted that the BODA provides the actual testing product the candidate experiences. BODA is preferably written using Java, JavaBeans, and Enterprise JavaBeans technologies; due to the inherent platform-independent nature of these technologies, compatibility problems related to test center configuration are reduced. Enterprise JavaBeans container 213b contains information necessary for this platform-independent implementation of BODA. Both applications communicate with TDMS 213 business objects and are instructed what to present next by TDMS 213. All candidate information and test results are captured in the TDMS database 213c.

The Test Administrator's system 215 (“Admin”) may be run from any testing station within the peer-to-peer testing network. Admin provides the necessary interfaces to allow the test center administrators to authenticate themselves with the system and to perform the following functions required to run the test center:

Apply software and test package updates

Control the tests available at the test center

Register testing candidates

Monitor test station status

Upload test results to eCBT servicing unit 270

Print score reports

Export candidate data

Create Irregularity Reports

Specify ADA (“Americans with Disabilities Act”) accommodations

Lock the Admin system

Print attendance rosters

Print EIR (“Electronic Irregularity Report”) Summary reports

Shutdown the TDMS

Installation process 216 support initial installation and subsequent re-installs of the eCBT test center 280 system. The installation process connects back to web server 207. This connection enables the process to authenticate the test center administrator through a shared secret and to retrieve the center's digital certificate. The connection also allows the installation process to collect detailed test center contact information, which is stored in the holding database 206.

Test packages and software may initially be provided to installation process 216 on physically transportable medium, such as optical medium 109.

It should be noted that test center 280 may be either physically or logically multi-tiered—that is, it may be implemented as several computing devices (e.g., one machine for test center administration, and a plurality of separate machines as testing stations), or it may be implemented on a single computing device (e.g., a laptop computer) which hosts both test center administration functions as well as testing station functions. When a single device is used, means for isolating those functions is needed (i.e., when the device is being used to deliver a test to an examinee, the examinee should not be able to access the test administrator interface to affect the testing conditions.)

FIG. 2B shows an alternative embodiment of the architecture shown in FIG. 2A. The architecture of FIG. 2B, like that of FIG. 2A comprises a back-end 260, an eCBT servicing unit 270, and a test center 280. However, in FIG. 2B, eCBT servicing unit 270 comprises a protocol engine 207a, as an alternative Java Enterprise Service implementations on web server 207 shown in FIG. 2A. Protocol engine 207a communicates with test center 280 using a layered networking protocol that may be particularly adapted for test delivery. An example of such a layered networking protocol is described in detail below in the detailed description of a preferred embodiment of protocol engine 207a.

FIG. 2C shows an example of a layered networking protocol 500. Layered networking protocol 500 may, for example, comprise a service layer 502, a service authorization layer 504, an encryption layer 506, an authentication layer 508, and a transport layer 510 (in the example of FIG. 2C, the transport layer is shown as the Hypertext Transport Protocol (HTTP)). The division of functionality across the layers varies among protocols. In one example, the division of functionality may be as follows: service layer 502 may provide a set of instructions to request and receive services such as delivery of new test forms from eCBT servicing center 270 to test center 280, or delivery of test answers from test center 280 to eCBT servicing center 270. Service authorization layer 504 may perform the function of determining whether a particular test center 280 is authorized to receive certain types of information—e.g., whether test center 280 is authorized to receive a particular test form. Encryption layer 506 may perform the encryption that allows sensitive information such as tests to be transmitted over a public network such as the Internet without compromising the security of the information. Authentication layer 508 may perform general authentication functions, such as determining that a particular test center 280 that contacts eCBT servicing center 270 is the actual test center that it claims to be. (These authentication functions may, for example, be performed by convention challenge-response protocols.) Transport layer 510 receives information from the higher layers and arranges for the delivery of the information according to a transport protocol, such as HTTP. There may be additional layers beneath transport protocol 510 (e.g., lower-level transport layers such as the Transport Control to Protocol (TCP), the User Datagram Protocol (UDP), and a physical layer).

In the example of FIG. 2C, each network node that participates in the communication is equipped with a protocol engine that implements the various layers of the protocol. For example, protocol engine 207a may be at installed at eCBT servicing center 270, as well as on a computing device at test center 280. Thus, using the protocol implemented by protocol engine 207a, eCBT servicing center 270 and test center 280 may communicate, as shown in FIG. 2C.

Administrative use-case scenarios

The following is a description of the various scenarios that may be carried out at test center 280 using test administrator system 215. Each of these actions may be carried out by a “Test Center Administrator” (TCA) (except where it is indicated that action is required by the testing candidate). The TCA is a person who operates the test center 280 and performs administrative functions related to the administration of computer-based tests at test center 280. Test administrator system 215 exposes an interface by which the TCA may perform the following scenarios:

Scenario: View and Install Updates

The TCA uses an interface (e.g., a Graphical User Interface or “GUI”) to choose the action “View and Install Updates.” The system responds with a list of available updates. The list will include software updates, test package updates and test package deadline dates. The TCA selects a number of updates to download. The system downloads the selected updates from eCBT servicing unit 270 to the TDMS. As the download occurs, the user interface indicates the percent of the data that had been downloaded. Software updates are unpacked and placed in the appropriate file structures, if required. The system then updates the list of available tests. The action ends when most recent software and test package updates, as selected by the TCA, are applied to the TDMS database 213c. Once a newer version of a test package has been applied, older versions of the same test package become inactive. Preferably, the system precludes updating a test when that test is in progress. Preferably, the system is also configured to save data cataloged prior to an interrupt or failure that occurs during a download, such that only the remaining data (i.e., the date that was not already downloaded) must be downloaded after reconnecting.

Scenario: Change Available Tests

The TCA uses an interface to choose the action “Change Available Tests.” An available test may be defined as one whose download is complete and the system date falls within the test's delivery window. The system responds with a list of all available tests, whose availability may be changed. The system sorts the list by test name and testing program. The TCA selects those tests that should (or should not) be available for testing. The system responds by updating the test center 280's list of available tests. Preferably, any change under this scenario will not affect any test that is in progress.

Scenario: Create EIR

The TCA uses an interface to choose to create an Electronic Irregularity Report (EIR). The system responds with a list of EIR types. The TCA chooses the appropriate EIR type. The system fills in the list of today's appointments (i.e. candidate/test combinations). The system also fills in the appropriate troubleshooting text for the selected EIR type. The TCA selects zero or more appointments, reads the troubleshooting text, enters a description of the irregularity and any action taken and selects “Submit”. The TCA then creates an EIR, which is logged in the TDMS database 213c for later upload to eCBT servicing unit 270 Preferably, contact information (e.g., the TCA's phone number) may be automatically added to the bottom of the problem text.

Scenario: Print Score Report

The TCA uses an interface to choose the action “print score report” and, optionally, may choose to sort the report by candidate name or by test. The system responds with a list of appointments and corresponding candidate birth dates. The TCA selects one or more Appointments to be printed. The TCA also selects the desired printer and presses “print”. The System prints the score reports and marks the score report results as printed.

Scenario: Send Results to eCBT servicing unit 270

The TCA uses an interface to indicate that results should be sent to eCBT servicing unit 270. The system establishes the connection to web server 207, if it is not already established. The results data is synchronized back to web server 207. Preferably, test results for all appointments are uploaded to web server 207. Preferably, all results are replicated, including intermediate results for multi-day ADA candidates.

Scenario: View Test Station Status

The TCA uses an interface to choose to view test station status. The system presents a list of all test stations 218 that are currently on-line. The TCA may choose a station 218 to view details. The System responds with test station details such as:

Testing status, including waiting, testing or operating the Admin system.

Configuration information, including hardware and software configuration, percentage of disk free etc.

If the testing status is testing, details include:

Candidate, test being delivered, ADA status

Session time

Time since last test station activity across the network

Scenario: View TDMS Info

The TCA uses an interface to choose to view TDMS information. The system responds with a list of details. Exemplary details that may be provided in this scenario:

Operating System Version

EJB Container resources and status

Operating System resources

Disk resources

Installed software

Database status

Scenario: End Open Sessions

The TCA uses an interface to indicate that all testing for the day should be ended. The System displays a list of stations with tests in progress. The TCA enters whether the test is chargeable for each test in the list. The system displays a list of stations that are up. The system notifies the TCA to proceed to the testing station and shut it down. Preferably, the TCA may force a shutdown remotely.

Scenario: Start/Restart a Test

The candidate enters his or her name at the testing station. The system displays a message, such as one asking the candidate to wait while the test is started. The candidate either begins taking the test, or resumes a test already in progress if this is a restart of a test.

Scenario: Set ADA Conditions

The TCA uses an interface to indicate that the candidate is an ADA candidate. The system responds with a list of ADA options (e.g., color selection, magnification software, section time multiplier, allow unlimited-untimed breaks, additional physical conditions, etc.). The TCA selects the desired ADA options, including indication of any additional physical accommodations supplied. If color selection or magnification is chosen (or some other attribute that can be immediately accommodated by the computer system 100 on which testing station 218 is implemented), the system responds by applying the accommodation to the selected testing station. Optionally, instead of requiring the TCA to enter ADA data at test center 280, data about particular candidates could be obtained as part of a test registration process and stored at eCBT servicing unit 270 so that it may be supplied to test center 280 as part of the test package delivery or synchronization process.

Scenario: Walk-In Registration (first model)

The TCA uses an interface to select the action “walk-in registration.” The system displays a list of Testing Programs. The TCA selects a testing program. The system displays a list of tests. The TCA selects one or more tests. The system is displays a candidate information form appropriate for the test selected. The TCA completes the candidate information screen. Minimal information is the candidate's name and method of payment. If the method of payment is check, money order or voucher, the system responds with the appropriate payment detail form. If the candidate is an ADA candidate, the TCA so indicates and the “Set ADA Conditions” scenario commences.

The system then displays a list of available testing stations. The TCA selects a testing station and chooses to start the test delivery process. The System sends the Appointment object to BODA to begin the test. The TCA directs or escorts the Candidate to the testing station. The ADA conditions (if applicable) are in effect at the selected testing station. The candidate then completes a computer-based test and all results are added to the TDMS database for later upload to eCBT servicing unit 270.

Scenario: Walk-In Registration (second model)

The TCA uses an interface to select the action “walk-in registration.” The system displays a list of testing programs. The TCA selects a testing program. The system displays a list of tests. The TCA selects one or more tests. The system displays a testing program-specific candidate information form. The TCA completes the candidate information screen including name, address and payment information. The system responds with the appropriate payment detail form, which the TCA completes. If the payment method is credit card, the system performs a preliminary validation and displays the test price and the candidate information for confirmation. The TCA confirms the candidate and payment information. The system determines if a photo is required and instructs the TCA to take a photo. The TCA takes a photo of the candidate (if required). If the electronic equipment is not equipped for digital photography, the system may instruct the TCA to take a conventional photograph. If conventional photography fails, an EIR should be filed. The system presents a list of available testing stations. If the candidate is an ADA candidate, the TCA so indicates and the set ADA conditions use case commences. The TCA selects a testing station and chooses to start the test delivery process. The system sends the appointment object to BODA to begin the test. The TCA directs or escorts the candidate to the testing station. If applicable, ADA conditions will be in effect at the testing station. The candidate then completes a computer-based test and all results are added to the TDMS database for later upload to eCBT servicing unit 270.

Scenario: TCA Check-in: Pre-Registered Candidate

The TCA uses an interface to select the action “check-in a pre-registered candidate.” The system responds with a list of appointments that have not been checked-in. The TCA selects an appointment. The system responds with detail information for the appointment. The TCA confirms the appointment details with the candidate (see “Scenario: Gather Name and Address Change”). The system determines if a photo is required and instructs the TCA to take a photo. The TCA takes a photo of the candidate (if required). The TCA uses an interface to launch the test. The system responds by sending the appointment object to BODA to begin the test. The TCA escorts the candidate to the testing station. The candidate begins the test. If the candidate is dissatisfied with the testing station, the TCA may use the system to reassign the candidate to a different testing station. The candidate completes a computer-based test and all results are added to the TDMS database for later upload to eCBT servicing unit 270.

Scenario: Photograph a Candidate

The TCA selects an appointment. The system responds with detail information for the appointment. The TCA uses an interface to selects the “photograph candidate” option, positions the camera, and captures the image. The system responds with a display of the image. The TCA reviews the quality of the image and accepts or retakes the photograph. The System responds by compressing the image and associating the image with the selected appointment. Alternatively, if digital photography is not available, the TCA must take a conventional photograph, and an EIR should be filed. If digital photography is successful, the candidate image is added to the TDMS database. Preferably, the image is stored in a compressed format (e.g., in a JAR file).

Scenario: Gather Name/Address Change

The TCA reviews the name and address information with the (pre-registered) candidate. The candidate indicates that a change is required. The TCA uses an interface to selects the action “name/address change.” The system responds with a facility to capture name and address information. The TCA enters the appropriate changes and indicates the type of supporting documentation for the change. The system responds by applying the changes to the candidate appointment information. Candidate name and address changes are then added to the TDMS database.

Scenario: TCA Check-in ADA Candidate: Day 1 (of multi-day test)

The TCA uses an interface to select the act “check-in a pre-registered candidate.” The system responds with a list of appointments that have not been checked-in. The TCA selects an appointment. The system responds with detail information for the appointment, including ADA options [color, magnification, time multiplier, number of days, etc]. The TCA confirms the appointment details with the candidate (see Scenario: Gather Name and Address Change). The system determines if a photo is required and instructs the TCA to take a photo. The TCA takes a photo of the candidate (if required). The TCA selects to verify the ADA options. The system responds with a facility to capture the ADA options supplied. The TCA enters the ADA options actually supplied. The system responds by applying ADA accommodations to the testing station, as appropriate. If the required ADA options cannot be supplied, the TCA must determine whether testing can proceed anyway. The TCA chooses to launch the test. The system sends the appointment object to BODA to begin the test. If the test is a multi-day test, the system indicates that a test is in session and effectively blocks updates to the test or test-delivery software for the duration of the test. The TCA escorts the Candidate to the testing station. The Candidate begins the test. BODA delivers the test. The system responds by removing any ADA options from the testing station. The candidate then takes a computer-based test and all results are added to the TDMS database for later upload to eCBT servicing unit 270. In the case of a multi-day test, those results will be intermediate.

Scenario: TCA Check-In Multi-day ADA Candidate: Day 2+ (of multi-day test)

The TCA uses an interface to select “check-in a pre-registered ADA candidate on the second or subsequent day.” The System responds with the list of multi-day appointments in-progress. The TCA selects an appointment. The system responds with detail information for the appointment, including ADA options applicable to the multi-day appointment. The System applies the ADA accommodations to the testing station, as appropriate. The TCA chooses to launch the test. The system sends the appointment object to BODA to begin the test. The TCA escorts the candidate to the testing station. The candidate begins the test. BODA restarts the test. The system responds by removing any ADA options from the testing station. If the multi-day test is now complete, the system removes indication that a multi-day test is in-progress, thereby removing any block to the updating of the test or testing software. The candidate then completes a computer-based test and all results are added to the TDMS database for later upload to eCBT servicing unit 270.

Scenario: TCA Stops a Test

The TCA goes to the target testing station 218 and chooses to stop the test (using an interface at testing station 218). The system responds by suspending the test. The test is suspended and its status is indicated in the TDMS database 213c.

Scenario: View Appointments

The TCA uses an interface to select “view appointments.” The system responds with a list of appointments in the local TDMS system 213. The TCA may choose to view additional appointments no longer resident in the local system (i.e. beyond the last synchronization point with the servicing unit 270). The system retrieves the appointments from the eCBT servicing unit 270 and responds with a list of appointments retrieved from a database available at such servicing unit 270. The TCA selects an appointment to view details. The system displays detail information for the selected appointment. TCA selects to view the list of appointments. The appointments may, for example, be sorted by candidate name, date, test or testing program. The system responds with the list of appointments sorted in the desired sequence. The TCS then is able to view the appointment information.

Scenario: Lock TDMS Software

The TCA uses an interface to select the “lock TDMS option.” Alternatively, the TDMS times out, which has the same effect. The system overlays the main window with the lock dialog. The TDMS software then enters a locked state and no further interaction is possible until it is unlocked.

Scenario: Unlock TDMS Software

The TCA enters the password to unlock the TDMS. The System responds by unlocking the TDMS and removing the challenge dialog from the main window. The TDMS software then enters an unlocked state and is available for interaction.

Scenario: Login/Start-up TDMS

The TCA chooses to start the TDMS. The system presents a challenge dialog. The TCA enters his or her name, phone number and the system password. The system determines if a modem dial-up connection is required and prompts for the Internet Service Provider (ISP) password. The TCA establishes the TCP/IP connection. The system validates the password with the eCBT servicing unit 270. The system downloads the package decryption keys, appointment information, a list of critical and available updates, retest information, review and challenge information, unread messages and intermediate multi-day test results. The system automatically displays the unread messages. The TCA may then choose to configure the site, and may also run a “sanity check.”

Scenario: Export Data

The TCA uses an interface to select the action “export data from the TDMS.” The system responds with a range of dates spanning the period since the last export together with a list of export formats. Default export format (e.g., SDF) is positioned at the beginning of the list. The TCA either accepts the date range provided or changes the ‘begin’ and/or ‘end’ dates for the date range. The TCA either accepts the default export format or selects an alternative export format. System responds with a “Save File” dialog initialized with a default file path. The TCA may either accept the default file path or select an alternative path. The system extracts data from TDMS database for date range selected, formats extracted data according to the export format selected, and writes formatted data to a file in the file path selected.

Scenario: Suspend Testing

The TCA uses an interface to select the action “suspend testing.” The system responds with a list of stations at which testing is in progress. The TCA may either choose one or more stations from the list and begin suspension of testing for selected stations, or cancel. The system suspends the test for each selected station. The system displays a message at selected station(s). After a predetermined period of time (e.g., 30 seconds), the system displays a lock screen (with no password dialog) at selected station(s). After a second predetermined period of time. the system displays a lock screen (containing a password dialog) at the TDMS.

Scenario: Resume Testing

The TCA chooses to resume testing. The system responds with a list of stations 218 at which testing has been suspended. The TCA may either choose one or more stations from the list and begin resumption of testing for selected stations 218, or cancel. The system displays a message at selected station(s) 218. When a candidate inputs “continue test,” the system resumes the test for station 218.

Scenario: Print Attendance Roster

The TCA uses an interface to select the action “print attendance roster.” The system extracts attendance data from the TDMS database and formats extracted data into a roster. The system displays “Print” dialog. The TCA either accepts the default printer or chooses an alternative. The system spools formatted roster to the chosen printer.

Scenario: Change Password

The TCA uses an interface to select the action “change password.” The interface then prompts the TCA to input a new password, checking the TCA's credentials (e.g., knowledge of the old password), as necessary.

System testing context

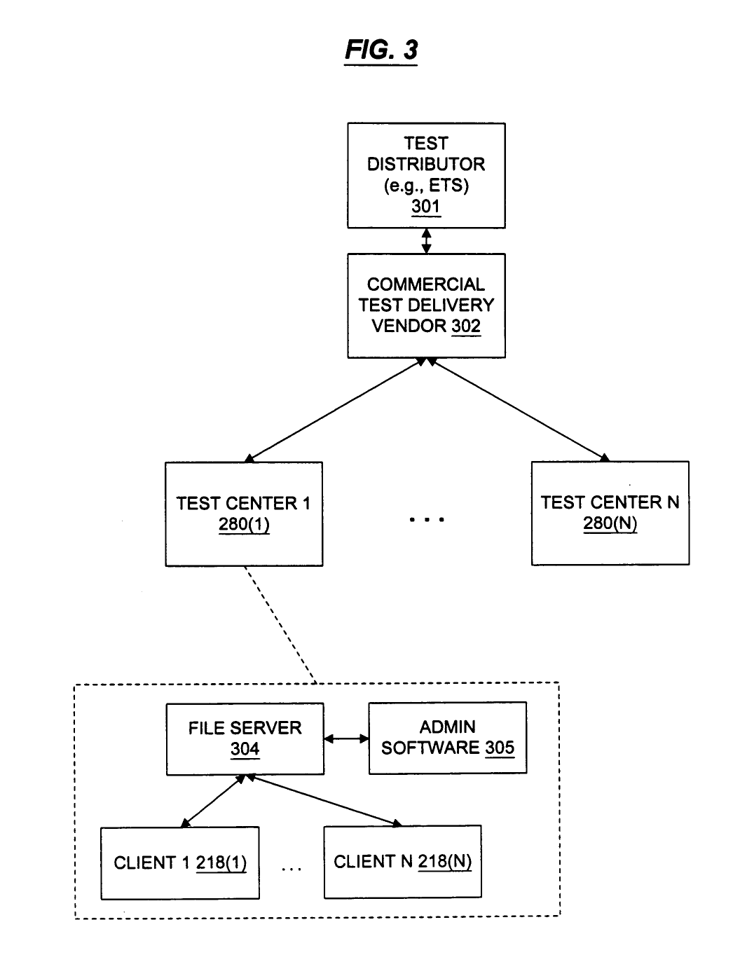

FIG. 3 shows the use of the eCBT system, as it might be deployed in a commercial context. Referring to FIG. 3, the tests to be administered under the eCBT system may be prepared by a test distributor 301, such as Educational Testing Service of Princeton, N.J. Preparation of the test may include the actual authoring of the test, as well as converting the test into a format usable with the distribution and delivery system. A test delivery vendor 302 could be engaged to operate the test centers and to distribute the testing materials to those test centers. In this example, test distributor 301 could be the operator of back-end 260, and test delivery vendor 302 could be the operator of eCBT servicing unit 270. In one exemplary model, test candidates may register with test distributor 301 to take a particular test, and test distributor 301 may provide “work orders” to test delivery vendor 302, whereby test delivery vendor 302 is specifically engaged to test a given candidate or a given group of candidates.

Continuing with the example of FIG. 3, test centers 280(1) through 280(N) may be operated by test delivery vendor 302. For example, test delivery vendor 302 could be headquartered at a particular location and may operate testing centers throughout the United States or throughout the world. Test delivery vendor 302 may communicate with its testing centers 280(1) through 280(N) by means of a private network (although a generally-available network such as the Internet could also be used). Alternatively, test delivery vendor 302 could provide data to its test centers by conventional physical delivery means, such as magnetic or optical media.

Each test center 280(1) through 280(N) may be configured as shown in FIG. 2A, or a test center may have the simplified configuration shown in FIG. 3, comprising a file server 304, administrative software 305 (which runs on file server 304), and several client testing stations 218(1) through 218(N) communicatively coupled to file server 304.

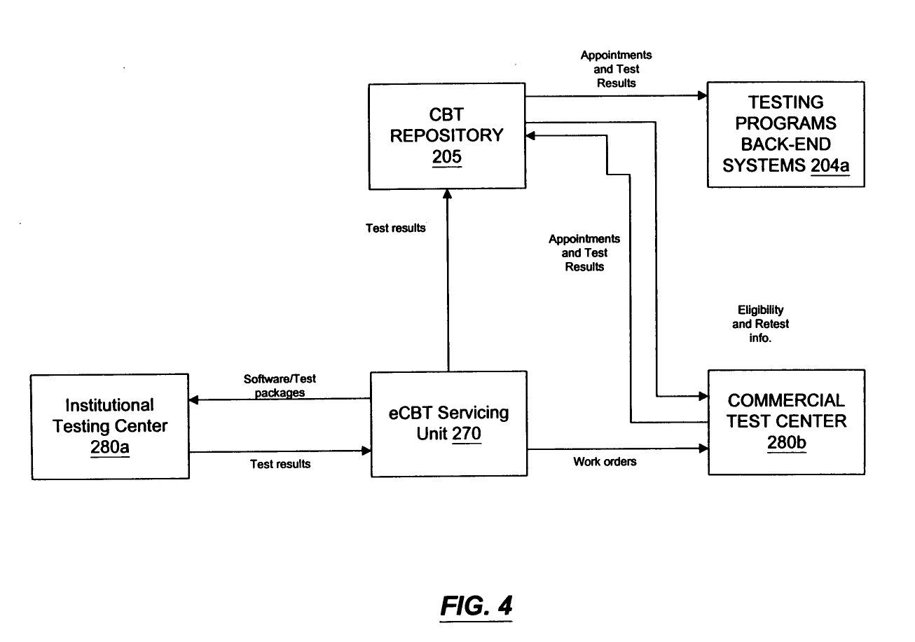

FIG. 4 shows an alternative context in which the present invention may be deployed to administer various types of tests. In this example, CBT repository 205 (shown in FIG. 2A) is interfaced to one or more back-end systems 204a. Back-end systems 204a may, for example, provide processing for tests such as the Graduate Record Examination (GRE), the Test of English as a Foreign Language (TOEFL), the Graduate Management Admissions Test (GMAT), etc. In the example of FIG. 4, a first group of tests may be administered at a first testing center, such as institutional testing center 280a (or group of testing centers), and a second group of tests may be administered at a second testing center, such as commercial testing center 280b (or group of testing centers). For example, a test delivery vendor may administer certain tests (e.g., those in the second group) at testing centers 280b operated by that test delivery vendor. eCBT servicing unit 270 is coupled to the single CBT repository 205 (which is accessible to the various types of back-end systems that are needed), and is also coupled to the various testing centers 280a and 280b, and it provides tests and software to both testing centers. Different tests and software may be provided to testing centers 280a and 280b, according to the particular tests that those testing centers administer. eCBT servicing unit 270 collects the test results from testing centers 280a and 280b, and provides it back to CBT repository 205 for processing by the appropriate back-end system 204a.

Exemplary Process of Providing a Test to Testing Center

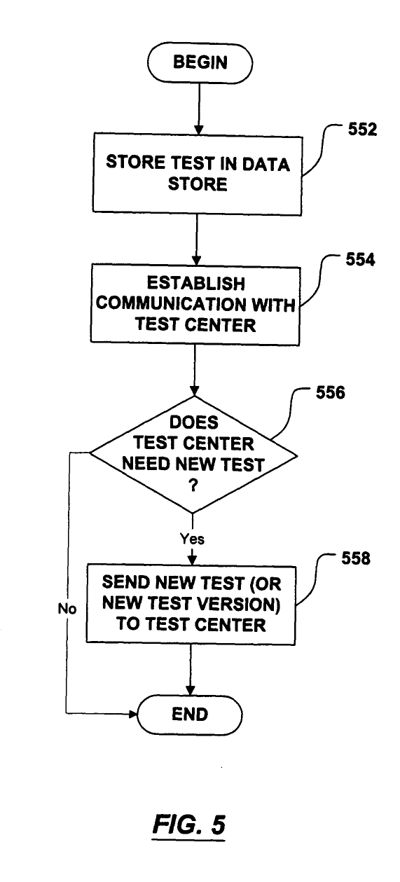

FIG. 5 shows an exemplary process of providing testing materials to a testing center. For example, such a process may be carried out between eCBT servicing center 270 and test center 280.

At step 552, tests are stored in a data store that is either within, or accessible to, eCBT servicing center 270. For example, tests may be stored at data storage object 203 shown in FIGS. 2A and 2B.

At step 554, communication is established between eCBT servicing center 270 and test center 280. This communication may be established according to a protocol, such as the protocol described below (or, alternatively, by a protocol in common use, such as TCP).

At step 556, a determination is made as to whether test center 280 needs to receive a new test. This determination may be based on various conditions—for example, test center 280 may have an out-of-date test form, or the test to be delivered may be a new test that has not yet been delivered to test center 280. This determination may be made by eCBT servicing center 270, based on information received during the communication at step 554.

If step 556 results in a determination that new testing materials need to be delivered to test center 280, then eCBT servicing center 270 sends the new testing materials to test center 280 (step 558). The materials are preferably encrypted, and this encryption, as noted above in connection with FIG. 2C, may be performed by the protocol engine itself. If step 556 results in a determination that no new testing materials are needed, then the process terminates without delivering new testing materials.

### Description of Exemplary Protocol Engine 207a

Protocol engine 207a (shown in FIG. 2B) will be described in detail in this section. Specifically, as previously noted, servicing center 270 and test center 280 may communicate by means of a network protocol. That network protocol may be implemented as an interface that comprises a set of methods and data objects. The following is a description of such an interface which implements an exemplary protocol. It will be understood by those of skill in the art that the methods and data objects described below are merely exemplary, and that a protocol may be implemented with different methods and data objects that facilitate communication between a servicing center and a test center.

While general-purpose communication protocols may be used to communicate test information between a test center and a servicing center, the following protocol is particularly well-adapted for that purpose. Thus, protocol engine 207a implements commands, as described below, that are particularly relevant for testing, such as an “is version allowed” function that checks a given test version to determine whether installation may proceed. Other methods in the interface perform actions such as transmitting test materials to the test center and retrieving test scores from the test center.

SvviContract Interface

This interface defines the contract between a View & Install client and its consumer. A View and Install client is an application that connects an eCBT servicing unit 270 using the Java Enterprise service to a View and Install service. This same contract is also implemented by the View & Install service and is invoked by the View & Install client acting as its stub.

Method Summary

| | Method Profile and Brief |
|---|---|
| Return Type | Description |
| java.util.HashMap | GetRefTables(java.util.HashMap tcRefTrck) |
| | This method fetches the reference table |
| | data from server side database and hands it |
| | over to the test center application. |
| VIReleaseResponse | GetReleaseResponse(java.lang.Long |
| | releaseNumber) |
| | For a given release number this method |
| | returns the release response corresponding to |
| | the release number. |
| VITestComponentDependencyResponse[] | GetTestComponentDepnencyResponse( |
| | VITestPackageCode packageCode) |
| | For a given test package code this |
| | method returns an array of the test component |
| | dependency response objects of type |
| | VITestComponentDependencyResponse. |
| VITestPackageResponse | getTestPackage( VITestPackageCode |
| | packageCode) |
| | For a given test package code this |
| | method returns the test package response |
| | objects of type VITestPackageResponse. |
| VIReleaseTestPackage[] | GetTestPackageReleases( ) |
| | SvviService returns the release-to-site |
| | mapping details destined to the site id of the |
| | calling site, in an array of response objects of |
| | type VIReleaseTestPackage when this method |
| | is called. |
| byte[] | GetTestSupportPackageComponent(java. |
| | lang.Long releaseNumber, java.lang.String |
| | szSftwrCmpntInstlPthTxt, java.lang.String |
| | szSftwrCmpntFleNam) |
| | This method fetches the test support |
| | package component. |
| VITestSupportPackageReleaseResponse[] | GetTestSupportPackageReleases( ) |
| | This method fetches the test support |
| | package release. |
| void | UploadReleaseStatus( VIReleaseStatus[] |
| | arStatus) |
| | This method uploads the release |
| | installation status information from test center |
| | to the server side. |
| VIReleaseDetails[] | validateTestPackageReleases( |
| | VIReleaseTestPackage[] aRel) |
| | This method is of historical |
| | significance, but is no longer in general use. In |
| | the previous release of this product this method |
| | returned the entire set of release information |
| | objects. This task is now done in stages by the |
| | methods described earlier. |

Methods inherited from other interfaces: wfClose, wfOpen The wfOpen method is used by
the framework services to authenticate the test center application and authorize its access to
services offered. The wfClose method signals the end of the session from the test center.

Method Details

uploadReleaseStatus
public void uploadReleaseStatus( VIReleaseStatus[] arStatus)

throws SvviMultiException

This method uploads the release installation status information from test center to
the server side.

| | |
|---|---|
| Actors | - tcApplication |
| | The test center application that requests the upload of release |
| | status info. |
| | - ecbt.WFSvviService |
| | The view&install service on the collector implemented by the |
| | SvviService class. |
| Entry Conditions | This method gets called (i) at the end of the site install |
| | process (ii) at the start of a release installation during |
| | view&install (iii) and at the end of a release installation |
| | during view&install in order to update the release status |
| | inforomation at server side holding database. |
| Exit Conditions | The release installation status regarding each test center gets |
| | updated into the server side holding database by the |
| | SvviService. |
| Normal Path | This method gets called at the end of the site install process as |
| | well as when ever the view&install client wants to update the |
| | relase status info. at server side holding DB. At the end of |
| | site install process the release status info. is updated into the |
| | collector's database. During the View&Install process |
| | tcApplication requests the SvviService to update the release |
| | status info. at server side holding DB. This update indicates |
| | the start of a release installation for the associated site id. At |
| | the end of each release installation during view&install, |
| | tcApplication again requests the SvviService to update release |
| | installation status. This update indicates the end of a release |
| | installation for the associated site id. |
| | This method first checks if the status row exists in the |
| | collector's holding database by the primary key fields |
| | contained in the input record. If a record exists it is updated, |
| | otherwise it is created. |
| Abnormal Path | An exception is thrown to indicate a failure to update server |
| | side database with the release installation status info. for the |
| | tcApplication. tcApplication will stop the installation process |
| | and will log an error message. |
| Notes | The site install application will proceed with rest of the |
| | functionality only if this method call returns successfully. The |
| | view&install application verifies the success of the method |
| | call return and continues with further view&install operation |
| | only on success. This service call ensures the synchronization |
| | of both test center and server side databases regarding the |
| | release installation status at a given test center. At the |
| | beginning of a release installation an install-start status flag is |
| | updated in both databases. When a test center conducts the |
| | view&install operation, if there is any problem in the process, |
| | the release-end status flag does not get updated in both |
| | databases. This indicates clearly that the specific test center |
| | did attempt to install a particular release but it did not |
| | succeed. This status information will be critical for the |
| | subsequent view&install operations to determine whether a |
| | particular release needs to be re-installed by a test center or |
| | not! |
| Parameters: | VIReleaseStatus - the object that holds details about the test |
| | center release status. |
| Throws: | SvviMultiException - thrown encapsulating any server side |
| | exceptions if they are detected for each element of the input |
| | argument. |

getRefTables
public java.util.HashMap getRefTables(java.util.HashMap tcRefTrck)

throws SvviException

This method fetches the reference table data from server side database and hands it
over to the test center application.

| | |
|---|---|
| Actors | - tcApplication |
| | The test center application that requests the reference table data. |
| | - ecbt.WFSvviService |
| | The view&install service on the collector implemented by the |
| | SvviService class. |
| Entry Conditions | This method is called at the beginning of view&install process |
| | initiated by the test center application. This method is |
| | triggered and is executed implicitely without user intervention |
| | during view&install task. The requisite reference data must |
| | have been populated in the server side database prior to this |
| | method call. The reference data's meta table REF_TRCK |
| | must have correct time stamps in both test center's local and |
| | server side holding databases. |
| Exit Conditions | The reference table data is returned to the tcApplication by |
| | SvviService from server side holding database for the tables |
| | that are outof date at the test center. |
| Normal Path | The test center application will read its REF_TRCK table and |
| | send the list of table names and their time stamps to the |
| | SvviService in the argument as a Map. The SvviService will |
| | examine the received Map and compare it against its own |
| | Map built from the collector's copy of REF_TRCK table. The |
| | SvviService will return a Map of reference table names and a |
| | corresponding Collection of business objects for each |
| | reference table that is newer in its Map. The Collection will |
| | be a complete set of entries for the named table. If no tables |
| | are sent then an empty Map will be returned. Note that this is |
| | not same as sending null. If a table is found in the collector |
| | side list but not in the test center list, it will be considered as |
| | new and sent to the test center. The returned Map will always |
| | contain the entries for REF_TRCK table itself that are being |
| | sent. This Collection will always be treated by the test center |
| | application as a partial business object because it is intended |
| | to update and not replace the REF_TRCK entries. If the |
| | SvviService finds that it is sending one or more of CNTRY, |
| | TST_PGM_CNTRY, ST_PROV, |
| | TST_PGM_ORG_CUST_RLE or TST_PGM tables, it will |
| | send them all. This is done to ensure that the referential |
| | integrity constraints imposed on these tables are always |
| | satisfied. Each Collection is the actual reference data for the |
| | reference table named as its key in the Map. The list of |
| | reference business objects is: VITestProgram, |
| | VIStateProvince, VITestProgramCountry, VICntry, |
| | VIPaymentMethod, VIAppointmentStatus, VIMessageData, |
| | VIMessageButton, VIResultManager, VIToolDisplay, |
| | VIToolDirList, VIResponseDisplay. The REF_TRCK data is |
| | returned in a collection of VIRefTrack objects. |
| Abnormal Path | An exception is thrown if the service fails to prepare a |
| | collection of the response reference data objects to be |
| | returned to the test center application. The test center will log |
| | the error and handle the exception appropriately. |
| | If the REF_TRCK table at the collector contains table(s) that |
| | are not in the list sent by the test center then these would |
| | always be sent by the SvviService. If the test center |
| | application does not have the class(es) that defines the |
| | business objects for these tables, it will log this as a |
| | Recoverable Error and continue processing. If the test center |
| | receives a business object for a table that it had named in its |
| | original list for which it does not have a class, it will log this |
| | as an Error and stop execution. If the SvviService fails to read |
| | its REF_TRCK table it will log an error and send an |
| | exception back to the test center application. The test center |
| | application will log this as an Error and stop execution. If the |
| | SvviService fails to read information in its REF_TRCK about |
| | a table named in the list from the test center it will log an |
| | error and send an exception back to the test center |
| | application. The test center application will log this as an |
| | Error and stop execution. |
| Notes | The test center application will update the refrence table data |
| | returned by svviService into local test center database. The |
| | the test center's ODBC:PACKAGES database will contain the |
| | REF_TRCK table entries that match the collector's view of |
| | the REF_TRCK entries. It will also contain the data in these |
| | tables that matches the collector's data in those tables. |
| Parameters: | tcRefTrck - is a Map which maps the table name to its time |
| | stamp as listed in the test center's REF_TRCK table. |
| Returns: | A Map which is keyed by the table names and contains a |
| | Collection of business objects that hold the table data. |
| Throws: | SvviException - thrown encapsulating any server side |
| | exceptions. |

getTestSupportPackageReleases
public VITestSupportpackageReleaseResponse[]
getTestSupportPackageReleases( )
throws SvviException

This method fetches the test support package release (viz. software release)
data from server side holding database except the software component blob
and hands it over to the test center application.

| | |
|---|---|
| Actors | - tcApplication |
| | The test center application that requests the software release data. |
| | - ecbt.WFSvviService |
| | The view&install service on the collector implemented by the |
| | SvviService class. |
| Entry Conditions | The software component tables should have been pre- |
| | populated in holding database at server side. |
| Exit Conditions | An array of test support package release response type of |
| | objects(each such object does not contain the software |
| | component blob) for the software releases marked for this site |
| | is returned by the SvviService. |
| Normal Path | 1. This service call to SvviService will attempt to fetch all |
| | available test support package(software component) releases |
| | for this site. The service will automatically identify the site id |
| | of the test center from the WF communication ‘Principal’. |
| | The service will find out which software releases for this site |
| | need to be returned by excluding the releases this site has |
| | already installed. |
| | 2. If there are any test support package releases available, |
| | SvviService will proceed to return an array of test support |
| | package release response objects. Otherwise the method |
| | throws an svviException with a message that no software |
| | release entities exist to be downloaded for this site id. |
| Abnormal Path | The service will throw an exception when it fails to fulfill the |
| | request of tcApplication. An exception must be analyzed by |
| | the test center application to identify if the server complains |
| | that there are no entities found for this site. If it is the case |
| | then tcApplication will consider it as a graceful exception and |
| | handle it as if it is a success. |
| Notes | 1. Local test center database auto commit feature will be in |
| | disabled mode. |
| | 2. tcApplication will receive a collection of software |
| | component release response objects that need to be installed |
| | locally. Each software component release response that needs |
| | to be installed will contain Release, SiteRelease and |
| | SoftwareComponent business objects. tcApplication will |
| | update tcDB for all releases iteratively as follows: |
| | (i) update the release and site release data for the |
| | software component going to be installed from the |
| | business objects. |
| | (ii) a flag that indicates start of current release (going to |
| | be installed) will be updated in both local (tcDB) and |
| | remote (hdDB) databases. |
| | (iii) from the same response objects obtained, |
| | tcApplication will extract the primary key for each |
| | software component release. tcApplication will then |
| | populate a cache with the PK's as keys and the |
| | corresponding SoftwareComponent business |
| | objects as values. |
| | 3. tcApplication will install the software component data for |
| | all releases iteratively. |
| | (i) tcApplication will verify if there are any duplicate |
| | software components in the entire collection received. |
| | (ii) If there exist any duplicates, only the one with |
| | higher release number will be installed and others will |
| | be skipped. For the skipped releases the installation |
| | status flag will not be updated in both tcDB and hdDB. |
| | This helps in indicating that these releases were |
| | attempted but skipped by the test center. |
| | (iii) The tcApplication will send a request to hdService |
| | to get software component blob which is a subsequent |
| | service call getTestSupportPackageComponent( ) for the |
| | primary key of current release from hdDB. |
| | tcApplication will insert a row for current release in |
| | software component table in tcDB. tcApplication will |
| | mark the install complete for the release by updating |
| | tcDB and hdDB with release success status flag. |
| | (iv) tcApplication will commit all changes to tcDB. |
| Parameters: | - No arguments required. |
| Returns: | VITestSupportPackageReleaseResponse[] an array of response |
| | business objects for all eligible software releases for this site. |
| Throws: | SvviException - thrown encapsulating any server side |
| | exceptions if they are detected. |

getTestSupportPackageComponent
public byte[] getTestSupportPackageComponent(java.lang.Long
releaseNumber, java.lang.String szSftwrCmpntInstlPthTxt,
java.lang.String szSftwrCmpntFleNam)

throws SvviException
This method fetches the test support package component (viz, software component)
blob from server side holding database and hands it over to the
test center application.

| | |
|---|---|
| Actors | - tcApplication |
| | The test center application that requests the software |
| | component blob data. |
| | - ecbt.WFSvviService |
| | The view&install service on the collector implemented by the |
| | SvviService class. |
| Entry Conditions | The service method getTestSupportPackageReleases( ) must |
| | have been called prior to this service call mandatorily by the |
| | tcApplication. The software component blob should have been |
| | pre-populated in holding database at server side for each of |
| | the software release made available to the test center. |
| Exit Conditions | The software component blob as a byte array is returned by |
| | the SvviService for a given primary key combination of a |
| | software release to which the blob belongs. |
| Normal Path | This service call to SvviService will attempt to fetch the |
| | software component blob for a given primary key |
| | combination of a software release to which the blob belongs. |
| | If the software component exists in holding database |
| | SvviService will return it as a byte array. Otherwise service |
| | will throw an exception with a message that no entity exists |
| | for the primary key. |
| Abnormal Path | The service will throw an exception when it fails to fulfill the |
| | request of tcApplication. If there exists an available test |
| | support package(software) release for current site, but there |
| | does not exist a software component blob for that release, this |
| | case will be considered by the tcApplication as an |
| | Unrecoverable Error and stop the execution by prompting |
| | with an error message. |
| Notes | The tcApplication will send a request to hdService to get |
| | software component blob for the primary key of current |
| | release from hdDB. This method generally downloads a huge |
| | software component jar to the test center. If this service call |
| | succeeds tcApplication will insert a row for current release in |
| | software component table in tcDB. if SvviService threw an |
| | exception tcApplication will consider this as an unrecoverable |
| | exception and aborts the view&install operation after logging |
| | an error message. |
| Parameters: | releaseNumber - the release number which is part of the key |
| | for sftwr_cmpnt table. |
| | szSftwrCmpntInstlPthTxt - the software component |
| | installation path which is part of the key for sftwr_cmpnt |
| | table. |
| | szSftwrCmpntFleNam - the software component file name |
| | which is part of the key for sftwr_cmpnt table. |
| Returns: | byte[] a byte array that holds the software component jar that |
| | gets downloaded to the test center. |
| Throws: | SvviException - thrown encapsulating any server side |
| | exceptions if they are detected. |

getTestPackageReleases
public VIReleaseTestPackage[] getTestPackageReleases( )

throws SvviException

SvviService returns the release-to-site mapping details destined to the site id of
the calling site, in an array of response objects of type VIReleaseTestPackage
when this method is called.

| | |
|---|---|
| Actors | tcApplication |
| | The test center application that requests the test package |
| | release details for the site. |
| | - ecbt.WFSvviService |
| | The view&install service on the collector implemented by the |
| | SvviService class. |
| Entry Conditions | The available test package release details, site details, and the |
| | test package attribute details for these releases must have been |
| | pre-populated in holding database prior to this method call. |
| | This method is called by the tcApplication during normal |
| | operation. |
| Exit Conditions | The release-site mappings and test package release details are |
| | returned to the tcApplication by SvviService. this identifies |
| | the list of available test package releases for this site whose |
| | site id is automatically deciphered from the WF security |
| | Principal by the collector service. |
| Normal Path | Test center makes this service call to the server to receive the |
| | available ‘release-test package’ lists for this test center/site. |
| | This method does not get the contents/components of the |
| | releases or test packages. This method only gets the available |
| | release and test package catalogs. As the Principal object of |
| | the WAN Framework possesses the siteId and test center Id, |
| | this method need not send these arguments again. This |
| | method must be called first in the sequence of calls being |
| | made to update available test packages to local test center. |
| | The following example shows the copmplete sequnce of a test |
| | package view & install: |
| | 1. The test center makes a request to |
| | getTestPackageReleases. The collector services responds |
| | by doing a search on its tables to determine the releases |
| | and their respective test packages that are available to |
| | the site, and not installed at this test center. The |
| | returned array may be represented in an abstract manner |
| | as follows: |
| | R1 T20 T30 |
| | R2 T21 T30 T40 T50 |
| | R3 T30 T40 T70 |
| | 2. The test center application proceeds to display the |
| | release number (Rx) and the descriptions (descrX) to the |
| | TCA. The associated Test Package Codes are held by |
| | the application is a cache but are not displayed to the |
| | TCA. When the TCA makes his/her selection the |
| | selected Release and their test packages codes are sent to |
| | collector for validateion via the |
| | validateTestPackageReleases call. The following |
| | assumes that the TCA had selected all three releases |
| | shown above: |
| | The validateTestPackageReleases arguments will be same as |
| | the response to getTestPackageReleases shown above. If the |
| | TCA had selected only the R2 and R3, the argument would |
| | have been the two elements for R2 & R3. The response from |
| | the collector will be: |
| | R2 T21 T50 |
| | R3 T30 T40 T70 |
| | Note that complete deletion of R1 as well as removal of T30 |
| | & T40 from R2. |
| | 3. The test center application will then proceed to download |
| | the appropriate test packages via getTestPackageReleaseData |
| | method. |
| Abnormal Path | The service will throw an exception when it fails to fulfill the |
| | request of tcApplication. tcApplication will consider it as an |
| | Unrecoverable Error and stop the execution by prompting |
| | with an error message. |
| Notes | tcApplication inserts the test package related release details, |
| | site release details into the tcDB. Then it validates the test |
| | package releases to see if there are any duplicate and |
| | superceded test packages and return an array of eligible |
| | objects that contains only the releases that completely satisfy |
| | the selected set without duplication. Thus it removes the |
| | duplicate or supreceded test package codes from lower |
| | numbered releases. |
| | It tries to see if a higher version of a test package exists in |
| | any of the already installed releases at the test center, if so, |
| | the lower version of the test package will not be installed in |
| | tcDB. |
| | If a higher version of an already installed test package is |
| | ready to be installed then the already installed test package is |
| | expired just one day before the start date of the latest fetched |
| | higher version package. |
| | SpecialCase: If a release has all test packages which are older |
| | versions than already installed test packages, and when |
| | presented to user for installation if user did not choose to |
| | install that release, in that case next iteration of view&install |
| | avoids displaying that release to user as an available release |
| | for installation. This is a very rare and special case. This case |
| | occurs because, this method returns all releases available to |
| | this site id for installation irrespective of whether a release |
| | has all lower/older versions of test packages than the ones in |
| | any other available releases being offered to the same site for |
| | installation. And that is designed to be so to allow users to |
| | choose and install a lower version packages-release, if they |
| | want. |
| Returns: | an array of objects that hold release specs for all available |
| | releases for this test center. The release spec contains the |
| | release number, its description and its associated list of |
| | available test packages. |
| Throws: | SvviException - thrown encapsulating any server side |
| | exceptions if they are detected. |

validateTestPackageReleases
public VIReleaseDetails[] validateTestPackageReleases(
VIReleaseTestPackage[] aRel)

throws SvviException

The test center application makes this call to register the selected releases for
installation. This method is invoked after the getTestPackageReleases method
and contains a subset of releases sent to test center by that method. The
service at the collector will cull these selected releases for duplicate and
superceded test packages and return an array of VIReleaseDetails objects that
contains only the releases that completely satisfy the selected set without
duplication. These objects contain all the information about the release not just
their description. They also contain the test package codes that must be
downloaded for each of the releases. The collector is responsible for removing
the duplicate or superceded test package codes from lower numbered releases.

| | |
|---|---|
| Parameters: | aRel - is the array of selected releases and their test packages |
| | held in a VIReleaseTestPackage object. |

getTestPackage
public VITestPackageResponse getTestPackage(VITestPackageCode
packagecode)

throws SvviException

For a given test package code this method returns the test package response
objects of type VITestPackageResponse.

| | |
|---|---|
| Actors | - tcApplication |
| | The test center application that requests the test package |
| | details for the given test package. |
| | - ecbt.WFSvviService |
| | The view&install service on the collector implemented by the |
| | SvviService class. |
| Entry Conditions | The service call getTestPackageReleases( ) completion is a |
| | mandatory prior-condition to this service call. The available |
| | test package details must have been pre-populated in holding |
| | database prior to this method call. This method is called by |
| | the tcApplication during normal operation. |
| Exit Conditions | A test package response object is returned to the tcApplication |
| | by SvviService. |
| Normal Path | This service call to SvviService will attempt to fetch the test |
| | package response object for a given test package code. |
| | SvviService will search the holding database for test package |
| | data for the given test package. This data encompasses the test |
| | components, theta conevrsion and calculations, component |
| | blocking and the test package attribute details. If the service |
| | finds any, it populates the test package response object and |
| | returns it. For those contained objects like theat details and |
| | blocking details service will populate empty collections in |
| | case if there is no data. Otherwise if not even a single record |
| | is found for the test package, the service will throw an |
| | exception with a message that no entities exist for the given |
| | test package code. |
| Abnormal Path | The service will throw an exception when it fails to fulfill the |
| | request of tcApplication. tcApplication will consider it as an |
| | Unrecoverable Error and stop the execution by prompting |
| | with an error message. |
| Notes | tcApplication will extract all associated contained business |
| | objects like theta details, component blocking details and the |
| | test compoennet details. tcApplication inserts all the extracted |
| | details data into tcDB. |
| Parameters: | packageCode - the code for which the dependencies are |
| | downloaded. The collector service interprets this the parent |
| | package code in the Test Component Dependency bean. |
| Returns: | VITestComponentDependencyResponse[] an array of |
| | component dependency objects for the test package code. |

getTestComponentDepnencyResponse
public VITestComponentDependencyResponse[]
getTestComponentDepnencyResponse(VITestPackageCode packageCode)
throws SvviException

For a given test package code this method returns an array of the test
component dependency response objects of type
VITestComponentDependencyResponse.

| | |
|---|---|
| Actors | - tcApplication |
| | The test center application that requests the test component |
| | dependecny details for the given test package. |
| | - ecbt.WFSvviService |
| | The view&install service on the collector implemented by the |
| | SvviService class. |
| Entry Conditions | The available test component dependency details must have |
| | been pre-populated in holding database prior to this method |
| | call. This method is called by the tcApplication during normal |
| | operation. |
| Exit Conditions | An array of test component dependency response objects is |
| | returned to the tcApplication by SvviService. |
| Normal Path | This service call to SvviService will attempt to fetch the test |
| | component dependency response objects for a given test |
| | package code. SvviService will search the holding database |
| | for test component dependency data for the given test |
| | package. If finds any, it returns them as an array of test |
| | component dependency business objects. Otherwise service |
| | will throw an exception with a message that no entities exist |
| | for the given test package code. |
| Abnormal Path | The service will throw an exception when it fails to fulfill the |
| | request of tcApplication. tcApplication will examine the |
| | exception to see if the service could nto find any entities. If |
| | there are no entities then this exception is considered graceful |
| | by the tcApplication and continue with rest of test package |
| | release installation in view&install process. If the exception |
| | thrown by the service is any other exception then |
| | tcApplication will consider it as an Unrecoverable Error and |
| | stop the execution by prompting with an error message. |
| Notes | tcApplication will insert a row in tcDB into the test |
| | component dependency table for each test component |
| | dependency response object returned in the array by the |
| | service. |
| Parameters: | packageCode - the code for which the dependencies are |
| | downloaded. The collector service interprets this the parent |
| | package code in the Test Component Dependency bean. |
| Returns: | VITestComponentDependencyResponse[] an array of |
| | component dependency objects for the test package code. |

getReleaseResponse
public VIReleaseResponse getReleaseResponse(java.lang.Long
releaseNumber)

throws SvviException

For a given release number this method returns the release response corresponding
to the release number.

| | |
|---|---|
| Actors | tcApplication |
| | The test center application that requests the release response |
| | object. |
| | - ecbt.WFSvviService |
| | The view&install service on the collector implemented by the |
| | SvviService class. |
| Entry Conditions | The available release details must have been pre-populated in |
| | holding database prior to this method call. This method is |
| | called by the tcApplication during normal operation. |
| Exit Conditions | The release response object that contains the release, |
| | siteRelease details is returned to the tcApplication by |
| | SvviService. |
| Normal Path | This service call to SvviService will attempt to fetch the |
| | release response object for a given release number. If the |
| | release data exists in holding database SvviService will return |
| | it as a release response business object. Otherwise service |
| | will throw an exception with a message that no entities exist |
| | for the given release number. |
| Abnormal Path | The service will throw an exception when it fails to fulfill the |
| | request of tcApplication. tcApplication will consider it as an |
| | Unrecoverable Error and stop the execution by prompting |
| | with an error message. This is an error because the service |
| | returned this release number in the first instance revealing |
| | that the release data exists for this release number and needs |
| | to be downloaded by the test center. |
| Notes | tcApplication will insert a row for current release in the |
| | release and site release tables in tcDB with the returned |
| | values in the response object. if SvviService threw an |
| | exception tcApplication will consider this as an unrecoverable |
| | exception and aborts the view&install operation after logging |
| | an error message. |
| Parameters: | releaseNumber - the long identifier for the release |
| Returns: | the information of the release in VIReleaseResponse |

SvviParcel Contract Interface

This interface defines the contract between the parcel client and its consumer. This same contract is implemented by both the View & Install and the Site Install modules. The SvviParcelService service implements this contract service. Both the clients will make these service calls to the same service.

Method Summary

| Return Type | Method Profile and Brief Description |
|---|---|
| byte[] | retrieveParcel( ) |
| | This method retrieves the encrypted |
| | parcel of symmetric encryption keys for the |
| | test packages for the site invoking this call. |
| byte[] | retrieveParcel(java.lang.String siteCode) |
| | This method retrieves the encrypted |
| | parcel of symmetric encryption keys for the |
| | test packages for the site code argument |
| | passed. |

Methods inherited from other interfaces: wfClose, wfOpen

```
Method Details
retrieveParcel
public byte[] retrieveParcel(java.lang.String siteCode)
                  throws SvviException
      This method retrieves the encrypted parcel of symmetric encryption
      keys for the test pckages for the site code argument passed.
```

| | |
|---|---|
| Actors | - tcApplication |
| | The test center application that requsests the parcel to be |
| | downloaded. |
| | - ecbt.WFSvviParcel |
| | The Parcel service on the collector implemented by the |
| | SvviParcelService class. |
| Entry | This method is called by the tcApplications during normal |
| Conditions | operation when the sitecode for the eCBT server is known. |
| Exit | The Parcel of encrypted symmetric keys is returned to the |
| Conditions | tcApplication by the ecbt.WFSvviParcel service. These |
| | encryption keys are themselves encrypted using the site's |
| | profile which is already installed at the site. |
| Normal | The service validates the siteCode passed as the argument |
| Path | against the siteCode contained in the security principal for the |
| | tcApplication. If these two siteCodes match then the service |
| | computes and returnes the encrypted parcel of symetric |
| | encryption keys. The LDAP Server at the collector is |
| | searched for the site's profile to compute the parcel. |
| Abnormal | An exception is thrown to indicate a failure to match the two |
| Path | siteCodes. An exception may be thrown to indicate a failure |
| | to lookup the site in the collector's LDAP Server for the site's |
| | profile. In either case, the tcApplication must abort the |
| | operation and proceed to error recovery. |
| | An exception is thrown if any other client (like view & install) |
| | except the site install client makes this service call. Other |
| | clients are implicitly detected on the collector side by failure |
| | of a match between the site code passed as the argument and |
| | the site code extracted from security principal for the |
| | tcApplication. |
| Notes | The tcApplication saves the retrieved parcel into the local |
| | database for later recovery and use by the Test Delivery |
| | Applications. The parcel is always stored in the database in its |
| | raw encrypted format. The decrypted parcel exists only in |
| | system memory for the short duration when the Test Delivery |
| | Application needs to retrieve its symmetric encryption key. |
| Para- | siteCode - the five-digit site code assigned to the test center's |
| meters: | site. The parameter site code can NOT be null. For the |
| | siteinstall client this argument is mandatory. |
| Returns: | a byte array that holds the entire parcel is returned. |
| Throws: | SvsiException - thrown encapsulating any server side |
| | exceptions if they are detected. |
| | IllegalStateException - thrown if the validatePassword was |
| | not called (or had failed) prior to calling this method. It is not |
| | decalred in the method signature as it is an unchecked |
| | exception. This is applicable for site install client only. |

```
retrieveParcel
public byte[] retrieveParcel( )
                  throws SvviException
      This method retrieves the encrypted parcel of symmetric encryption
      keys for the test pckages for the site invoking this call.
```

| | |
|---|---|
| Actors | - tcApplication |
| | The test center application that requsests the parcel to be |
| | downloaded. |
| | - ecbt.WFSvviParcel |
| | The Parcel service on the collector implemented by the |
| | SvviParcelService class. |
| Entry | This method is called by the tcApplications during normal |
| Conditions | operation. |
| Exit | The Parcel of encrypted symmetric keys is returned to the |
| Conditions | tcApplication by the ecbt.WFSvviParcel service. These |
| | encryption keys are themselves encrypted using the site's |
| | profile which is already installed at the site. |
| Normal | The service validates the siteCode by verifying if the siteCode |
| Path | contained in the security principal for the tcApplication is not |
| | null. If it is not null, then the service computes and returnes |
| | the encrypted parcel of symetric encryption keys. The LDAP |
| | Server at the collector is searched for the site's profile to |
| | compute the parcel. |
| Abnormal | An exception is thrown to indicate a failure to match the two |
| Path | siteCodes. An exception may be thrown to indicate a failure |
| | to lookup the site in the collector's LDAP Server for the site's |
| | profile. In either case, the tcApplication must abort the |
| | operation and proceed to error recovery. |
| | An exception is thrown if any other client (like site install) |
| | except the view & install client makes this service call. Other |
| | clients are implicitely detected on the collector side by |
| | verifying if the site id extracted from WF security principal is |
| | null (when this service call is made). |
| Notes | The tcApplication saves the retrieved parcel into the local |
| | database for later recovery and use by the Test Delivery |
| | Applications. The parcel is always stored in the database in its |
| | raw encrypted format. The decrypted parcel exists only in |
| | system memory for the short duration when the Test Delivery |
| | Application needs to retrieve its symmetric encryption key. |
| Para- | - No parameter argument required. |
| meters: | |
| Returns: | byte[] a byte array that holds the entire parcel is returned. |
| Throws: | SvsiException - thrown encapsulating any server side |
| | exceptions if they are detected. |

SvsiContract Interface.

This interface defines the contract between the Site Install client and its consumer. This same contract is also implemented by the Site Install service and is invoked by the site install client acting as its stub.

Data Summary

| Type | Property Name and Description |
|---|---|
| static java.lang.String | TC_INSTALL_TIMESTAMP_PROP |
| | property name for installation |
| | timestamp |
| static java.lang.String | TC_OS_PROP |
| | property name for Test Center OS |
| static java.lang.String | TC_OS_VERSION_PROP |
| | property name for the Test Center OS |
| | Version |
| static java.lang.String | TC_VERSION_PROP |
| | property tag name for Test Center |
| | installed version string |

Method Summary

| Return Type | Method Profile and Brief Description |
|---|---|
| SiteDetails | getSiteDetails(java.lang.String siteCode) |
| | Returns the site details for a given site |
| | code. |
| java.lang.String | insertTC(java.lang.String siteCode, |
| | java.lang.String tcName, java.lang.String |
| | connType, java.lang.Integer idleTime, |
| | java.lang.String autoPrint, java.lang.String |
| | pcTopology, java.lang.Long timestamp, |
| | java.lang.String tdmsStatus, java.lang.String |
| | nextApntmt, java.lang.String password, |
| | java.lang.String admRetCode) |
| | Saves the test center information in the |
| | collectors database after a successful install at |
| | the test center. |
| java.lang.Boolean | isVersionAllowed(java.lang.String version) |
| | Checks the given version to verify that |
| | is allowed for an installation to proceed. |
| byte[] | retrieveProfile(java.lang.String siteCode) |
| | Retrieves the site profile from the |
| | server. |
| java.lang.Boolean | updateTC(java.lang.String siteCode, |
| | java.lang.String tcNum, java.lang.Long |
| | nextUtilizationSessionNum) |
| | Updates the remaining fields of the test |
| | center record after it has been created at the |
| | test center. |
| java.lang.Boolean | updateTC(java.lang.String siteCode, |
| | java.lang.String tcNum, java.lang.String |
| | tcName) |
| | Updates the Test Center Name for an |
| | existing test center. |
| java.lang.Boolean | updateTestCenterInfo(java.lang.String |
| | siteCode, java.lang.String tcNum, |
| | java.util.Properties prop) |
| | Updates collector's database with test |
| | center information stored in properties. |
| java.lang.Boolean | validatePassword(java.lang.String siteCode, |
| | java.lang.String[] aszPass) |
| | Validates the security secrets for a |
| | given site, before other controlled calls. |

Methods inherited from ther interfaces: wfClose, wfOpen

```
Field Details
TC_VERSION_PROP
public static final java.lang.String TC_VERSION_PROP
      property tag name for Test Center installed version string
TC_INSTALL_TIMESTAMP_PROP
public static final java.lang.String TC_INSTALL_TIMESTAMP_PROP
      property name for installation timestamp
TC_OS_PROP
public static final java.lang.String TC_OS_PROP
      property name for Test Center OS
TC_OS_VERSION_PROP
public static final java.lang.String TC_OS_VERSION_PROP
      property name for the Test Center OS Version
Method Details
getSiteDetails
public SiteDetails getSiteDetails(java.lang.String siteCode)
Conditionsthrows SvsiException
      Returns the site details for a given site code. There is no
      authentication required for this method as it is often used
      during site installation to show the details we know about
      the site to the installer. The information returned is in a
      data object defined in this package.
```

| | |
|---|---|
| Actors | tcInstaller - test center installer |
| Entry | test center installer should have test center number ready |
| Conditions | |
| Exit | test center should have the site details information for test |
| Conditions | center administrator to verify. |
| Normal | the method site details retrieve from database and return data |
| Path | to tcInstaller |
| Abnormal | Error will be raised if test site code is not found in database |
| Path | or other type of system error |
| Notes | |
| Para- | siteCode - the five-digit site code assigned to the test center's |
| meters: | site. |
| Returns: | the site information - usually the entire row for the site code |
| | from the tst_ctr_site table - is returned. |
| Throws: | SvsiException - thrown encapsulating any server side |
| | exceptions if they are detected. |

validatePassword

| | |
|---|---|
| public java.lang.Boolean validatePassword( | java.lang.String siteCode, |
| | java.lang.String[] aszPass) |

throws SvsiException

```
      Validates the security secrets for a given site, before other
      controlled calls.
```

| | |
|---|---|
| Actors | - tcInstaller - test center installer |
| Entry | test center installer should have the site installer secrets ready |
| Conditions | |
| Exit | unchanged |
| Conditions | |
| Normal | the method will match secrets in database for the site code, |
| Path | succeed code will be returned for match and failure will be |
| | returned for incorrect secrets |
| Abnormal | Error will be raised if test site code is not found in database |
| Path | or other type of system error |
| Notes | This method must be called before any other method in the |
| | service. The return state from this method is maintained by |
| | the server in the client's state hashmap. It can be called more |
| | than once but every call resets the state. |
| Para- | siteCode - the five-digit site code assigned to the test center's |
| meters: | site. |
| | aszPass - the password in correct order. Each string is a |
| | shared secret. The order of these secrets is important and |
| | must be preserved from the user input all the way to the Site |
| | Install service's validatePassword method. |
| Returns: | True is returned if the validation succeeds, false otherwise. |
| Throws: | SvsiException - thrown encapsulating any server side |
| | exceptions if they are detected. |
| insertTC | |

| | |
|---|---|
| public java.lang.String insertTC( | java.lang.String siteCode, |
| | java.lang.String tcName, |
| | java.lang.String connType, |
| | java.lang.Integer idleTime, |
| | java.lang.String autoPrint, |
| | java.lang.String pcTopology, |
| | java.lang.Long timestamp, |
| | java.lang.String tdmsStatus, |
| | java.lang.String nextApntmt, |
| | java.lang.String password, |
| | java.lang.String admRetCode) |

throws SvsiException

```
      Saves the test center information in the collectors database
      after a successful install at the test center. The test center calls
      this method prior to updating its local database with this
      information.
      A failure in this method is reported to the installer as failure to
      install. On success, this method returns the test centenr number
      assigned to the newly created test center. The client is required to
      use this number and install the information in its local database.
      This method can not be called more than once by a client. This
      method can not be called until the last call to validatePassword
      method has succeeded.
```

| | |
|---|---|
| Actors | - tcInstaller - test center installer |
| Entry | test center installer should have the successfully validated |
| Conditions | secrets. |
| Exit | test center information are saved in collector's database |
| Conditions | |
| Normal | the method will save supplied data in TST_CTR table in |
| Path | collector's database. |
| Abnormal | Error will be raised if test site code is not found in database |
| Path | or other types of system error |
| Notes | |
| Para- | siteCode - the five-digit site code assigned to the test center's |
| meters: | site. |
| | tcName - the (at most) 40 character string the defines the |
| | name of the testing center. |
| | connType - the single character connection code used by the |
| | test center. It can be (D: DialUp, L: OnLine, P: Proxy). |
| | idleTime - the number of seconds the admin screen can stay |
| | idle without prompting for password. We let the client select |
| | the default. |
| | autoPrint - a single character (Y/N) for automatic scroe |
| | printing. |
| | pcTopology - a single character (Y/N) whether this is |
| | standalone. |
| | timestamp - the time in seconds at the test center. |
| | tdmsStatus - the one caharcater tdms status code. |
| | nextApntmt - the next appointment number used by this test |
| | center. |
| | password - the deprecated password string - no longer used. |
| | admRetCode - the single character admin screen return code |
| | (0/1/2). |
| Returns: | A string containg a six-digit Test Center number is returned. |
| | This is a String and not an Integer to comply with the DDL, |
| | though we do generate it as if it is a number to keep it |
| | compatible with the legacy code. |
| Throws: | SvsiException - thrown encapsulating any server side |
| | exceptions if they are detected. |
| | IllegalStateException - thrown if the validatePassword was |
| | not called (or had failed) prior to calling this method. It is not |
| | decalred in the method signature as it is an unchecked |
| | exception. |
| updateTC | |

| | |
|---|---|
| public java.lang.Boolean updateTC( | java.lang.String siteCode, |
| | java.lang.String tcNum, |
| | java.lang.Long |
| nextUtilizationSessionNum) | |

throws SvsiException

```
      Updates the remaining fields of the test center record after it has
      been created at the test center. This method can not be called
      unless a inserTC has been called before.
```

| | |
|---|---|
| Actors | - tcInstaller - test center installer |
| Entry | test center installer should have the successfully validated |
| Conditions | secrets. |
| Exit | test center information are updated in collector's database |
| Conditions | |
| Normal | the method will save supplied data in TST_CTR table in |
| Path | collector's database. |
| Abnormal | Error will be raised if test site code is not found in database |
| Path | or other types of system error |
| Notes | |
| Para- | siteCode - the five-digit site code assigned to the test center's |
| meters: | site. |
| | tcNum - the six-digit test center number assigned by the |
| | insertTC call. |
| | nextUtilizationSessionNum - the next utilization number that |
| | this center has elected to use. The legacy code used to |
| | generate this number by multiplying the tcNum with 10**6. |
| | The new implementation lets the test center code determine |
| | this number and puts no new restrictions on it. The tcNumber |
| | can be as high as 999999, when multiplied by 10**6, so the |
| | number can start as high as (10**12 - 10**6) = 0xD495CDC0 |
| | and could reach as high as 10**12-1 = 0xD4A50FFF. |
| | This should be a long. |
| Returns: | True is returned on success, a failure may be indicated by |
| | either a False or exception. |
| Throws: | SvsiException - thrown encapsulating any server side |
| | exceptions if they are detected. |
| | IllegalStateException - thrown if the validatePassword or |
| | insertTC had not succeeded prior to calling this method. It is |
| | not decalred in the method signature as it is an unchecked |
| | exception. |
| updateTC | |

| | |
|---|---|
| public java.lang.Boolean updateTC( | java.lang.String siteCode, |
| | java.lang.String tcNum, |
| | java.lang.String tcName) |

throws SvsiException

```
      Updates the Test Center Name for an existing test center. This is
      called if the Test Center Administrator wishes to change
      the name without modifying any other fields.
```

| | |
|---|---|
| Actors | - tcInstaller - test center installer |
| Entry | test center installer should have the successfully validated |
| Conditions | secrets. |
| Exit | test center information are saved in Collector's database |
| Conditions | |
| Normal | the method will save supplied data in TST_CTR table in |
| Path | collector's database. |
| Abnormal | Error will be raised if test site code is not found in database |
| Path | or other types of system error |
| Notes | |
| Para- | siteCode - the five-digit site code assigned to the test center's |
| meters: | site. |
| | tcNum - the six-digit test center number assigned during |
| | installation. |
| | tcName - the (at most) 40 character string the defines the |
| | name of the testing center. |
| Returns: | True is returned on success, a failure may be indicated by |
| | either a False or exception. |
| Throws: | SvsiException - thrown encapsulating any server side |
| | exceptions if they are detected. |
| | IllegalStateException - thrown if the validatePassword or |
| | insertTC had not succeeded prior to calling this method. It is |
| | not decalred in the method signature as it is an unchecked |
| | exception. |

```
retrieveProfile
public byte[] retrieveProfile(java.lang.String siteCode)
                      throws SvsiException
      Retrieves the site profile from the server.
```

| | |
|---|---|
| Actors | - tcInstaller - test center installer |
| Entry | test center installer should have the successfully validated |
| Conditions | secrets. |
| Exit | unchanged |
| Conditions | |
| Normal | read the profile for the given site code and return it to caller |
| Path | |
| Abnormal | Error will be raised if test site code is not found in database |
| Path | or other types of system error |
| Notes | test center installer will save the received profile at the |
| | appropriate location in the file-system. |
| Para- | siteCode - the five-digit site code assigned to the test center's |
| meters: | site. |
| Returns: | a byte array that holds the entire profile is returned. |
| Throws: | SvsiException - thrown encapsulating any server side |
| | exceptions if they are detected. |
| | IllegalStateException - thrown if the validatePassword was |
| | not called (or had failed) prior to calling this method. It is not |
| | decalred in the method signature as it is an unchecked |
| | exception. |

```
isVersionAllowed
public java.lang.Boolean isVersionAllowed(java.lang.String version)
                      throws SvsiException
      Checks the given version to verify that is allowed for an
      installation to proceed.
```

| | |
|---|---|
| Actors | - tcInstaller - test center installer |
| Entry | no |
| Conditions | |
| Exit | unchanged |
| Conditions | |
| Normal | base on collector's knowledge to determine a given version is |
| Path | allowed |
| Abnormal | Error will be raised if system error |
| Path | |
| Notes | |
| Para- | version - the current version string of the client program |
| meters: | |
| Returns: | true (Boolean) if version is an acceptable version. false |
| | otherwise. |

```
UpdateTestCenterInfo
public java.lang.Boolean updateTestCenterInfo(java.lang.String
siteCode, java.lang.String tcNum, java.util.Properties prop)
                      throws SvsiException
      Updates collector's database with test center information stored
      in properties.
```

| | |
|---|---|
| Actors | - tcInstaller - test center installer |
| | - tcApplication |
| Entry | no |
| Conditions | |
| Exit | specified properties saved in collector's database |
| Conditions | |
| Normal | determine test center for the given site code and test center |
| Path | number exists. Save specified properties in database. |
| Abnormal | Error will be raised if system error |
| Path | |
| Notes | The only accepted property in properties are |
| | TC_VERSION_PROP, |
| | TC_INSTALL_TIMESTAMP_PROP, TC_OS_PROP and |
| | TC_OS_VERSION_PROP. |
| Para- | siteCode - the site code for which test site to be update |
| meters: | tcNum - the Test center number to which information would |
| | be updated |
| | prop - contains name-value pair of a number of client |
| | information |
| Returns: | always true |
| Throws: | SvsiException - thrown encapsulating any server side |
| | exceptions if they are detected. |

SvruContract Interface

This interface defines the contract between the Result Upload client and its consumer. This same contract is also implemented by the Result Upload service and is invoked by the Result Upload client acting as its stub. None of the methods in this contract send the site code and test center number to the service. The WAN Framework is responsible for sending this information transparently and securely to the appropriate service.

Method Summary

| Return Types | Method Profile and Brief Description |
|---|---|
| SvruBatchSequence[] | getProcessedBatchNum( ) |
| | Returns an array of processed batch |
| | numbers to the test center, which is expected |
| | to remove them from its (and collector's) |
| | collection of transmitted but not processed |
| | batches. |
| SvruBatchSequence[] | getRejectedBatchNum( ) |
| | Returns an array of rejected sequence |
| | numbers to the test center, which is expected |
| | to re-send them using the rewriteOneRow |
| | method described below. |
| void | removeProcessedBatchNum( |
| | SvruBatchSequence[] aszBatchNum) |
| | Deletes the batches on the collector's |
| | database that have been marked as processed. |
| void | rewriteOneRow(java.lang.String szBatch, |
| | java.lang.Long seqNum, java.lang.Long |
| | chkSum, java.lang.String szTable, |
| | java.lang.String szKeyGroup, java.lang.Long |
| | sizeCmp, java.lang.Long sizeUncmp, byte[] |
| | ayRawData) |
| | Re-Writes one row of batch data to the |
| | holding database, if a row with these batch and |
| | sequence numbers does not exist, then an |
| | SvruException is thrown. |
| void | setLastConnectTime(java.lang.Long tstmp) |
| | Updates the collector's copy of the last |
| | connection time for End-of-Day process from |
| | the test center. |
| void | writeOneRow(java.lang.String szBatch, |
| | java.lang.Long seqNum, java.lang.Long |
| | chkSum, java.lang.String szTable, |
| | java.lang.String szKeyGroup, java.lang.Long |
| | sizeCmp, java.lang.Long sizeUncmp, byte[] |
| | ayRawData) |
| | Writes one row of batch data to the |
| | holding database, if a row with these batch and |
| | sequence numbers exists, then an |
| | SvruException is thrown. |

Methods inherited from other interfaces: wfClose, wfOpen

```
Method Details
setLastConnectTime
public void setLastConnectTime(java.lang.Long tstmp)
                      throws SvruException
      Updates the collector's copy of the last connection time for
      End-of-Day process from the test center.
```

| | |
|---|---|
| Actors | - tcApplication |
| | The EOD Application started by the Test Center |
| | Administrator. |
| | - ecbt.WFSvru |
| | The ResultUpload service on the collector implemented by the |
| | SvruService class. |
| Entry | This use case starts at the start of the EOD process. The |
| Conditions | tcApplication uses this to indicate a start of collector |
| | connection. |
| Exit | The time stamp for EOD attempt maintained by the collector |
| Conditions | for this siteCode and test center is changed to reflect the time |
| | stamp supplied by the tcApplication. |
| Normal | The collector service validates the siteCode and testcenter |
| Path | number supplied by the authentication principal and updates |
| | the EOD connection time for the test center in the TST_CTR |
| | table for this test center. |
| Abnormal | An exception is thrown if the test center does not exist on teh |
| Path | collector. |
| Notes | The tcApplication updates its entry for the last connection |
| | attempt in its TST_CTR table and proceeds with the next use |
| | case in the suite of End-of-Day operations. This time is stored |
| | at the Holding Database and is available for later retrieval and |
| | reporting. The time sent is always in GMT. We assume that |
| | the local system administrator has done the right thing by |
| | setting the system clock to local time and set the correct time |
| | zone. If not, we can not rely on this information. |
| Para- | tstmp - is the number of seconds since epoch in GMT |
| meters: | |
| Throws: | SvruException - thrown encapsulating any server side |
| | exceptions if they are detected. |

getRejectedBatchNum
public SvruBatchSequence[] getRejectedBatchNum()

throws SvruException

```
      Returns an array of rejected sequence numbers to the test center,
      which is expected to re-send them using the rewriteOneRow
      method described below.
```

| | |
|---|---|
| Actors | - tcApplication |
| | The EOD Application started by the Test Center |
| | Administrator. |
| | - ecbt.WFSvru |
| | The ResultUpload service on the collector implemented by the |
| | SvruService class. |
| Entry | This is the first use case invoked by the tcApplication. The |
| Conditions | tcApplication must be ready to retransmit the rejected rows |
| | when it starts this use case. |
| Exit | The collector service returns the set of sequence numbers that |
| Conditions | must be re-transmitted by this test center. |
| Normal | The collector service looks up its data for the given siteCode |
| Path | and test center number and returns a set of sequence numbers |
| | that were previously received from this test center and were |
| | later rejected by the the collector application(s). The collector |
| | maintains the list of sequence numbers received from the test |
| | center in the TST_CTR_TRNSM table. The state of the |
| | TST_CTR_TRNSM_SNT_FLG column determines |
| | whether the sequence number, given by the |
| | TST_CTR_TRNSM_SEQ_NO, is being processed, rejected |
| | or processed. The collector service does not change the state |
| | of its flags, it ouly reports those seq numbers that have a |
| | rejected status. If no rejected sequences are discovered for the |
| | calling test center (as is normally the case) then an empty |
| | array is returned. A null is never returned by the collector. |
| Abnormal | If the collector service fails to find any records for the calling |
| Path | test center, it throws an exception back indicating the exact |
| | reason for the failure. |
| Notes | The test center application, when it receives the list of |
| | rejected sequences is expected to re-transmit the rejected |
| | sequence numbers by invoking the rewriteOneRow method on |
| | each of the seq numbers. |
| Returns: | Returns an array of objects containing the batch numbers and |
| | sequence numbers on the collector that are marked as |
| | rejected. This will return an empty array if nothing was found |
| | on remote as rejected, but it will never return null. |
| Throws: | SvruException - thrown encapsulating any server side |
| | exceptions if they are detected. |

getProcessedBatchNum
public SvruBatchSequence[]getProcessedBatchNum()

throws SvruException

```
      Returns an array of processed batch numbers to the test center,
      which is expected to remove them from its (and collector's)
      collection of transmitted but not processed batches.
```

| | |
|---|---|
| Actors | - tcApplication |
| | The EOD Application started by the Test Center |
| | Administrator. |
| | - ecbt.WFSvru |
| | The ResultUpload service on the collector implemented by the |
| | SvruService class. |
| Entry | This use case is invoked by the tcApplication after re- |
| Conditions | tramsmitting the previously rejected sequences and having |
| | transmitted newly created batches. |
| Exit | The collector service returns the set of batch numbers that |
| Conditions | have been successfully processed by the collector. |
| Normal | The collector service looks up its data for the given siteCode |
| Path | and test center number and returns a set of batch numberes |
| | that were previously received from this test center and were |
| | later successfully processed by the the collector application(s). |
| | The collector maintains the list of batch numbers received |
| | from the test center in the TST_CTR_TRNSM table. The |
| | state of the TST_CTR_TRNSM_SNT_FLG column |
| | determines whether the batch number, given by the |
| | TST_CTR_TRNSM_BAT_NO, is being processed, rejected |
| | or processed. The collector service does not change the state |
| | of its flags, it only reports those batch numbers that have a |
| | processed status. If no processed batch numbers are |
| | discovered for the calling test center, then an empty array is |
| | returned. A null is never returned by the collector. |
| Abnormal | If the collector service fails to find any records for the calling |
| Path | test center, it throws an exception back indicating the exact |
| | reason for the failure. |
| Notes | The test center application, when it receives the list of |
| | processed batch numbers is expected to remove them from |
| | collector by invoking the removeProcessedBatchNum method. |
| | The tcApplication then removes these batches from its own |
| | database. |
| | A batch is a collection of sequences that collectively defines a |
| | single unit of work for an Endo-of-Day operation at the test |
| | center. A batch is uniquely identified by a row in |
| | TST_CTR_TRNSM table with sequence number 0. This row |
| | is used as a semaphore by the tcApplication and is always the |
| | last row to be written for the batch. The collector applications |
| | do not start processing anything from a batch until its seq |
| | number 0 becomes available. |
| Returns: | Returns objects containing the batch numbers on the remote |
| | database that are marked as processed. Unlike the rejected |
| | batches this method does not return the sequence numbers as |
| | only a complete batch (all sequences in it) can be marked as |
| | processed, while sequences (rows in a batch) are rejected |
| | individually. This will return an empty string array if nothing |
| | was found on remote as processed, but it will never return |
| | null. |
| Throws: | SvruException - thrown encapsulating any server side |
| | exceptions if they are detected. |

removeProcessedBatchNum

| public void removeProcessedBatchNum( | | SvruBatchSequence[] |
|---|---|---|
| | | aszBatchNum) |
| | throws | SvruException, |

SvruUnprocessedBatch-
Exception

```
      Deletes the batches on the collector's database that have
      been marked as processed.
```

| | |
|---|---|
| Actors | - tcApplication |
| | The EOD Application started by the Test Center |
| | Administrator. |
| | - ecbt.WFSvru |
| | The ResultUpload service on the collector implemented by the |
| | SvruService class. |
| Entry | This use case begins when the tcApplication has received a |
| Conditions | non-empty response to its getProcessedBatchNum request. |
| Exit | The batches identified by the numbers given as the arguments |
| Conditions | are removed from the collector's database, |
| Normal | All the rows (sequences) identified by the given batch |
| Path | number(s) in the method's argument are removed from the |
| | collector's database. The TST_CTR_TRNSM table on the |
| | collector is the only table affected by this operation. |
| Abnormal | An exception is thrown if one or more rows from the table |
| Path | could not be removed. The tcApplication aborts the process to |
| | remove the processed batches and proceeds with the rest of |
| | the End-of-Day application. |
| Notes | An abnormal conditions encountered during this use case are |
| | logged by the tcApplication. None of these conditions are |
| | fatal and hence the tcApplication proceeds wit the rest of the |
| | End-of-Day process. The local rows that are marked as |
| | processed on the collector are removed regardless of the error |
| | at the collector. The tcApplication - rightly - assumes that the |
| | errors reported at the collector end have nothing to do with |
| | the processed status of the batch, instead it is a processing |
| | error on the operation to remove the batch. By removing the |
| | batches from the local database, the tcApplication obviates the |
| | need for a response from the collector as to which batches |
| | failed to be removed. |
| Para- | aszBatchNum - an array of objects containing the batch |
| meters: | numbers to be removed from the holding database. |
| Throws: | SvruException - thrown encapsulating any server side |
| | exceptions if they are detected. |
| | SvruUnprocessedBatchException - thrown if an unprocess |
| | batch is detected in the list of batch numbers to be deleted. |
| | This exception is thrown at the end of processing by the |
| | service and thus it contains all batch numbers that were |
| | requested but found unprocessed. The batch numbers in the |
| | aszBatchNum that were found to be processed will be |
| | removed as expected. |

writeOneRow

| public void writeOneRow( | java.lang.String szBatch, |
|---|---|
| | java.lang.Long seqNum, |
| | java.lang.Long chkSum, |
| | java.lang.String szTable, |
| | java.lang.String szKeyGroup, |
| | java.lang.Long sizeCmp, |
| | java.lang.Long sizeUncmp, |
| | byte[] ayRawData) |

| | |
|---|---|
| throws | SvruException, |

SvruDataLostException

```
      Writes one row of batch data to the holding database, if a row with
      these batch and sequence numbers exists, then an
      SvruException is thrown.
```

| | |
|---|---|
| Actors | - tcApplication |
| | The EOD Application started by the Test Center |
| | Administrator. |
| | - ecbt.WFSvru |
| | The ResultUpload service on the collector implemented by the |
| | SvruService class. |
| Entry | This use case begins when the test center application has a |
| Conditions | new sequence to send to the collector for processing. |
| Exit | At the successful completion of this use case, the collector's |
| Conditions | database will have a new row for processing. |
| Normal | A row in the TST_CTR_TRNSM table in the collector's |
| Path | database is inserted with the information supplied in the |
| | method parameters. |
| Abnormal | Any failure to insert this row will result in an exception. The |
| Path | tcApplication aborts the rest of the End-of-Day operation on |
| | these exceptions as they are indeed fatal. |
| Notes | A successful insert for a sequence in the collector's database |
| | leads to the next sequence number to be added. The sequences |
| | numbers in a batch are always written to the collector in |
| | descending order. This ensures that the row for sequence |
| | number 0 is always written last. This row is used by the |
| | collector application(s) as a semaphore to start processing the |
| | batch. |
| Para- | szBatch - a max 32 character string that uniquely identifies |
| meters: | the batch of transmission. This is made by the test center |
| | consumer from the site code, test center number and a |
| | utilization number. It is a 17 character numeric string in |
| | current implementation but the DDL will accept a 32- |
| | character alpha numeric string. |
| | seqNum - a number that distinguishes one row of data in |
| | batch from another. This number is arbitrarilly assigned by |
| | the test center consumer when creating the result upload data. |
| | In the current implementation it begins with 0 and increments |
| | by 100 for every new record. Earlier implementations used |
| | the gap of 100 to add fragments of data if necessary. That |
| | practice is now deprecated with introduction of WAN |
| | Framework but the gap remains for backward compatibility. |
| | chkSum - the checksum of the data as computed by the |
| | consumer. |
| | szTable - the name of the table being transported in this data |
| | sequence. |
| | szKeyGroup - the group this table belongs to. This string is |
| | used by the asynchronous process in the holding database to |
| | force referential integrity over the dataset when importing this |
| | data. Usually an entire key group is either accepted or |
| | rejected by the process, but we always look at the records |
| | individually - by the table name - because that is necessary |
| | and sufficient for our purposes. |
| | sizeCmp - the number of bytes in the data being sent up - |
| | compressed. |
| | sizeUncmp - the number of bytes is the data after it is |
| | uncompressed. |
| | ayRawData - the data itself. |
| Throws: | SvruException - thrown encapsulating any server side |
| | exceptions if they are detected. |
| | SvruDataLostException - thrown if the server does not |
| | receive the number of bytes expected (sizeCmp). |

rewriteOneRow

| public void rewriteOneRow( | java.lang.String szBatch, |
|---|---|
| | java.lang.Long seqNum, |
| | java.lang.Long chkSum, |
| | java.lang.String szTable, |
| | java.lang.String szKeyGroup, |
| | java.lang.Long sizeCmp, |
| | java.lang.Long sizeUncmp, |
| | byte[] ayRawData) |

throws SvruException,
SvruDataLostException

```
      Re-Writes one row of batch data to the holding database,
      if a row with these batch and sequence numbers does not
      exist, then an SvruException is thrown.
```

| | |
|---|---|
| Actors | - tcApplication |
| | The EOD Application started by the Test Center |
| | Administrator. |
| | - ecbt.WFSvru |
| | The ResultUpload service on the collector implemented by the |
| | SvruService class. |
| Entry | This use case begins when the test center application has a |
| Conditions | row for a rejected sequence number ready to re-transmit to |
| | the collector for reprocessing. This is always as a result of |
| | non-empty response from the getRejectedBatchNum. |
| Exit | At the successful completion of this use case, the collector's |
| Conditions | database will have a new row for re-processing. |
| Normal | A row in the TST_CTR_TRNSM table in the collector's |
| Path | database is updated with the information supplied in the |
| | method parameters. |
| Abnormal | Any failure to update this row will result in an exception. The |
| Path | tcApplication aborts the rest of the End-of-Day operation on |
| | these exceptions as they are indeed fatal. |
| Notes | A rejected batch is treated same as a collection of rejected |
| | sequence numbers. The only difference being that the entire |
| | set of sequences belonging to the batch number are marked as |
| | rejected. Because of this reason, the tcApplication always |
| | sorts the retrieved list of rejected sequence numbers in |
| | descending order before proceeding to re-write them. This |
| | ensure that the sequence number 0 - if it exists - will always |
| | be the last one to be written. |
| Para- | szBatch - a max 32 character string that uniquely identifies |
| meters: | the batch of transmission. This is made by the test center |
| | consumer from the site code, test center number and a |
| | utilization number. It is a 17 character numeric string in |
| | current implementation but the DDL will accept a 32- |
| | character alpha numeric string. |
| | seqNum - a number that distinguishes one row of data in |
| | batch from another. This number is arbitrarilly assigned by |
| | the test center consumer when creating the result upload data. |
| | In the current implementation it begins with 0 and increments |
| | by 100 for every new record. Earlier implementations used |
| | the gap of 100 to add fragments of data if necessary. That |
| | practice is now deprecated with introduction of WAN |
| | Framework but the gap remains for backward compatibility. |
| | chkSum - the checksum of the data as computed by the |
| | consumer. |
| | szTable - the name of the table being transported in this data |
| | sequence. |
| | szKeyGroup - the group this table belongs to. This string is |
| | used by the asynchronous process in the holding database to |
| | force referential integrity over the dataset when importing this |
| | data. Usually an entire key group is either accepted or |
| | rejected by the process, but we always look at the records |
| | individually - by the table name - because that is necessary |
| | and sufficient for our purposes. |
| | sizeCmp - the number of bytes in the data being sent up - |
| | compressed. |
| | sizeUncmp - the number of bytes is the data after it is |
| | uncompressed. |
| | ayRawData - the data itself. |
| Throws: | SvruException - thrown encapsulating any server side |
| | exceptions if they are detected. |
| | SvruDataLostException - thrown if the server does not |
| | receive the number of bytes expected (sizeCmp). |

SvsrmContract Interface

Method Summary

| Return Type | Method Profile and Brief Description |
|---|---|
| SvsrmPatch□ | getAvailablePatches(java.lang.String version. |
| | java.lang.Long sequenceNumber) |
| | Returns the appropriate list of patches |
| | for the given version and patch sequence |
| | number. |
| SvsrmComponent | getComponent(java.lang.Long |
| | componentNumber) |
| | Retrieves the component for a given |
| | component number. |

Methods inherited from other interfaces: wfClose, wfOpen

Method Details

getAvailablePatches
public SvsrmPatch[] getAvailablePatches(java.lang.String version,

java.lang.Long
sequenceNumber)

throws SvsrmVersionDeactivatedException,

SvsrmException

Returns the appropriate list of patches for the given version and
patch sequence number. That is all available patches for the
given verion which sequence number is greater than the given
sequence number.
Actors

- tcApplication - test center installer or TDMS server

Entry Conditions

no

Exit Conditions

no

Normal Path

The service will query collector's database
to see any more patches with sequence
number larger than seqenceNumber is
available. If exists, a list of patches will be
returned. Or if no more patches for the
given version and sequence number, an
empty list is returned

Abnormal Path

Error will be raised if system error

Notes

Parameters:

version - the current version of eCBT
software running sequenceNumber - the
last sequence number the client obtain
from the service. −1 should be used if no
previous sequence number has been
downloaded.

Returns:

array of patches. An array with zero length
in case no more patches available for the
given parameters or no entry for the
version.

Throws:

SvsrmVersionDeactivatedException - for
version is flagged not active
SvsrmException - for all other application
exception situation

getComponent
public SvsrmComponent getComponent(java.lang.Long
componentNumber)

throws SvsrmException

Retrieves the component for a given component number.
Actors

tcApplication - test center installer or TDMS server

Entry Conditions

no

Exit Conditions

no

Normal Path

The service would query
SYS_SFTWR_CMPNT for the given
component number. An SvsrmComponent
object will be created with data from
database and returned.

Abnormal Path

Error will be raised if system error or if
component number not found.

Notes

Parameters:

componentNumber - the unique
component number for the component

Returns:

the component object

Throws:

SvsrmException - for all application
exception situation

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses. Those skilled in the art, having the benefit of the teachings of this specification, may effect numerous modifications thereto and changes may be made without departing from the scope and spirit of the invention in its aspects.

1. A method of distributing testing materials comprising the acts of:
storing a first version of a test package in a data store;
establishing a communication link with a test center via a wide-area network;
detecting, via said communication link, that a second version of said test package installed at said test center is outdated relative to said first version of said test package; and
transmitting said first version of said test package to said test center via said network.

2. The method of claim 1, wherein said establishing act comprises establishing said communication link via the Internet.

3. The method of claim 1, wherein said storing act comprises storing said first version of said test package in a database.

4. The method of claim 1, wherein said establishing act comprises using a Java Enterprise service to engage in communication with said test center.

5. The method of claim 4, wherein said Java Enterprise service is one of ThinWEB servlet or JRUN V3.0.

6. The method of claim 1, wherein said detecting act comprises:
receiving a test center record indicative of test packages installed at said test center, said test center record indicating the presence or absence of one or more versions of said test package at said test center;
determining, based on said test center record, that said first version of said test package is not installed at said test center.

7. The method of claim 6, further comprising the act of:
prior to said transmitting act, determining, according to a criterion, that said first version of said test package may be installed at said test center.

8. The method of claim 7, wherein said act of determining that said first version of said test package may be installed at said test center comprises the act of using an isVersionAllowed function which checks a version of software installed at said test center to determine whether an installation may proceed.

9. The method of claim 1, further comprising the act of:
updating a test center record at said test center to reflect installation of said first version of said test package at said test center.

10. The method of claim 1, wherein said transmitting act comprises:
packaging said test package in one or more data structures according to a first protocol; and
sending said one or more data structures to said test center via said wide-area network using a transport protocol different from said first protocol.

11. The method of claim 10, wherein said transport protocol comprises Hypertext Transport Protocol.

12. A method of operating a testing center comprising the acts of:
establishing, via a wide-area network, a communication link with a first server remote from said testing center;
transmitting, to said first server via said communication link, first information indicative of a version of testing materials installed at said testing center;
receiving, from said first server via said communication link, first testing materials comprising one or more test questions; and
electronically delivering said test questions to an examinee at said testing center.

13. The method of claim 12, wherein said establishing act comprises establishing said communication link via the Internet.

14. The method of claim 12, wherein said establishing act comprises using a Java Enterprise service to engage in communication with said first server.

15. The method of claim 14, wherein said Java Enterprise service is one of ThinWEB servlet or JRUN V3.0.

16. The method of claim 12, wherein said transmitting act comprises transmitting a test center record indicative of a status of said testing center, said status including an identity of testing materials installed at said testing center.

17. The method of claim 12, further comprising the act of:
transmitting, to said first server, property information indicative of software installed at said testing center.

18. The method of claim 12, further comprising the acts of:
receiving, via said wide-area network, using a transport protocol and at least one other protocol that packages information according to said transport protocol, data indicative of said test center installation status; and
storing said information at said test center.

19. The method of claim 12, wherein said transmitting act comprises:
packaging said first information in one or more data structures according to a first protocol; and
sending said one or more data structures to said first server via said wide-area network using a transport protocol different from said first protocol.

20. The method of claim 19, wherein said transport protocol comprises Hypertext Transport Protocol.

21. A system for computer-based testing comprising:
a test-delivery management module which receives testing materials via a wide-area network, said test-delivery management module having a database which stores the received testing materials, said test-delivery management module further hosting first client-server logic which retrieves the testing materials from said database; and
a testing-station module which receives the testing materials from said test-delivery management module in a manner controlled by said first client-server logic, said testing-station module having a user interface which presents the testing materials to a candidate in a manner controlled by said first client-server logic.

22. The system of claim 21, wherein said first client-server logic comprises Java.

23. The system of claim 21, wherein said test-delivery management module uses a protocol engine which implements a test-servicing protocol to receive said testing materials via said wide-area network, said protocol engine being installable on a computing device at a test servicing center with which said test-delivery management system communicates via said wide-area network, the protocol engine being adapted to communicate between the test servicing center and said test-delivery management module, said protocol engine comprising:
a service module which generates service data that provides a service to a testing center at which said test-delivery management module operates;
a service authorization module which is communicatively coupled to said service module, which receives the service data, and which engages in an authorization inquiry with the test-delivery management module to determine whether said test servicing center may perform said service for said testing center, and which forward said service data to said testing center according to a result of said authorization inquiry;
an encryption module which is communicatively coupled to said service authorization module, which receives data from said service authorization module, and which encrypts said data; and
an authentication module which receives encrypted data from said encryption module and which engages in an authentication protocol with said testing center prior to forwarding said encrypted data to said testing center, said authentication module forwarding said encrypted data using a transport protocol different from the test servicing protocol.

24. A protocol engine which implements a test servicing protocol, the protocol engine being installable on a computing device at a test servicing center, the protocol engine being adapted to facilitate communication between the test servicing center and a testing center, the protocol engine comprising:
a service module which generates service data that provides a service to the testing center;
a service authorization module which is communicatively coupled to said service module, which receives the service data, and which engages in an authorization inquiry with the testing center to determine whether said test service center may perform said service for said testing center, and which forward said service data to the testing center according to a result of said authorization inquiry;
an encryption module which is communicatively coupled to said service authorization module, which receives data from said service authorization module, and which encrypts said data; and
an authentication module which receives encrypted data from said encryption module and which engages in an authentication protocol with said testing center prior to forwarding said encrypted data to said testing center, said authentication module forwarding said encrypted data using a transport protocol different from the test servicing protocol.

25. The protocol engine of claim 24, wherein said transport protocol comprises Hypertext Transport Protocol or Secure Hypertext Transport Protocol.

26. The protocol engine of claim 24, wherein said authentication protocol comprises a challenge-response protocol.

27. The protocol engine of claim 24, wherein said service comprises provision of testing materials to the testing center.

28. The protocol engine of claim 27, wherein said authorization inquiry determines whether the testing center is authorized to receive said testing materials.

29. The protocol engine of claim 24, wherein said service comprises provision of an updated version of a test to the testing center, the testing center previously storing an outdated version of the test.
